(19) United States
(12) Patent Application Publication
(10) Pub. No.: US 2023/0385400 A1
(43) Pub. Date: Nov. 30, 2023

(54) DECENTRALIZED INTEROPERABLE CROSS SUBNET ARCHITECTURE

(71) Applicant: ToposWare, Inc., Cambridge, MA (US)

(72) Inventors: Theo Kevin Gauthier, Cambridge, MA (US); Sebastien Paul-Edouard Thomas Dan, Cambridge, MA (US); Monir Hadji, Cambridge, MA (US)

(21) Appl. No.: 18/202,074

(22) Filed: May 25, 2023

Related U.S. Application Data
(60) Provisional application No. 63/346,752, filed on May 27, 2022.
(60) Provisional application No. 63/350,805, filed on Jun. 9, 2022.

(51) Int. Cl. G06F 21/44; G06F 16/27

(52) U.S. Cl. CPC G06F 21/44; G06F 16/27

(57) ABSTRACT

An interoperable subnet system may include multiple subnets. A subnet may execute one or more operations and generate a proof of computational integrity of the one or more operations. The subnet may include a certificate interface that generates a certificate of the proof of computational integrity associated with the subnet. The system may also include a certificate-recording system in communication with the subnets. The certificate-recording system stores a plurality of certificates from different subnets. The certificates stored allow the subnet to perform verification and to execute cross-subnet operations. In some embodiments, the certificates may include zero-knowledge proof and the certificate-recording system may enforce weak causality connections among certificates to allow fast verification of certificates while preserving privacy of each subnet.

### CROSS REFERENCE TO RELATED APPLICATIONS

The application claims the benefit of U.S. Provisional Application No. 63/346,752, filed on May 27, 2022 and U.S. Provisional Application No. 63/350,805, filed on Jun. 9, 2022, both of which are incorporated by reference herein for all purposes.

### FIELD

The disclosure generally relates to an interoperable computer system and, more specifically, to an interoperable subnet system that includes a certificate-recording system that includes proofs of validity of operations in various subnets.

### BACKGROUND

Distributed system and blockchain technology are evolving very fast. Blockchain technology is on its way to challenge the performance of centralized systems with different blockchain projects now reaching a throughput in the thousands of transactions per second. Conventionally, blockchain technology has mainly focused on creating very sparse and standalone networks, all decoupled one another, trying to solve different challenges. Such heterogeneity has forged a future of blockchain leaning towards the coexistence of multiple layer-1 chains over the domination of a single network. The proliferation of application-specific blockchains and smart contract platforms hosting new instances of protocols will continue to accelerate the general adoption of the technologies. The need for interoperability continues to grow considerably.

### SUMMARY

Embodiments relate to a system that may include a first subnet and a certificate recording system. The first subnet may include a first subnet computing node and a certificate interface in communication with the first subnet computing node, wherein the first subnet computing node includes one or more processors and memory, the memory storing code including instructions, wherein the instructions, when executed, cause the one or more processors to: execute one or more operations of the first subnet, and generate a proof of computational integrity of the one or more operations; and wherein the certificate interface is configured to generate a first certificate of the proof of computational integrity associated with the first subnet. The certificate-recording system may be in communication with the first subnet. The certificate-recording system is configured to store a plurality of certificates from a plurality of subnets, the plurality of certificates including the first certificate associated with the first subnet and a second certificate associated with a second subnet different from the first subnet.

In some embodiments, the first subset further includes a virtual machine that is configured to execute the instructions through the first subnet computing node, the virtual machine configured to execute a protocol for generating a zero-knowledge proof of the one or more operations, the zero-knowledge proof being the proof of computational integrity.

In some embodiments, the instructions stored in the memory of the first subnet computing node, when executed, further cause the one or more processors to: receive a cross-subnet request from the second subnet; receive a certificate of the second subnet from the certificate-recording system, the certificate containing a proof of the cross-subnet request; verify the proof in the certificate; and execute the cross-subnet request based on the proof.

In some embodiments, the certificate interface is configured to execute a protocol in generating certificates, the protocol is shared among the plurality of subnets.

In some embodiments, the first certificate includes: a state proof that a state of the first subnet is valid; a list of one or more cross-subnet messages initiated from the first subnet to one or more other subnets; and an inclusion proof that the list of one or more cross-subnet messages are included in the state of the first subnet.

In some embodiments, the first subnet is configured to operate in a plurality of states, each state including one or more operations, and the proof of computational integrity in the first certificate certifies validity of the one or more operations in one of the states compared to a previous state.

In some embodiments, the system may further include a blockchain configured to issue a plurality of blockchain units, wherein the blockchain units are used as staking tools for a node to participate in the certificate-recording system.

In some embodiments, the first subnet is configured to conduct a transaction of a wrapped token of a public blockchain that is outside of the plurality of subnets.

In some embodiments, the first subnet and the second subnet are configured to perform a cross-subnet operation that to verify the first certificate associated with the first subnet and the second certificate associated with the second subnet, and both certificates being stored in the certificate-recording system and the one or more operations of the first subnet being concealed from the second subnet in the cross-subnet operation.

In some embodiments, the first certificate stored in the certificate-recording system verifies the validity of the one or more operations of the first subnet but do not include sufficient information to conduct the one or more operations.

In some embodiments, the certificate-recording system is configured to arrange the plurality of certificates in a partial order under a plurality of threads.

In some embodiments, the first subnet includes a consensus mechanism that allows a plurality of computing nodes to decide whether to generate the first certificate and the certificate-recording system is consensusless.

In some embodiments, the first subnet implements a Turing-complete virtual machine and the certificate-recording system is non-Turing-complete.

In some embodiments, the first subnet is a blockchain network and the certificate-recording system is a non-blockchain network.

In some embodiments, the disclosure is related to a certificate-recording system, including: a first certificate-recording computing node includes one or more processors and memory, the memory storing code including instructions, wherein the instructions, when executed, cause the one or more processors to: receive a plurality of certificates from a plurality of subnets, each certificate submitted by one of the subnets and including a proof of computational integrity of one or more operations of the one of the subnets; store the plurality of certificates that are retrievable by one or more subnets, wherein the plurality of certificates includes a subset of certificates corresponding to a first subnet, the subset of certificates are stored in a causal order with respect to the first subnet; receive a request from a second subnet to retrieve one or more certificates from the subset of certificates corresponding to the first subnet; and transmit the one or more certificates to the second subnet as a proof that one or more operations in the first subnet is valid, wherein the one or more certificates corresponding to the first subnet allows the second subnet to execute a cross-subnet operation with the first subnet.

In some embodiments, the certificate-recording system may further include a plurality of additional certificate-recording computing nodes configured to store the plurality of certificates, wherein at least a second certificate-recording computing node of the plurality of additional certificate-recording computing nodes stores the plurality of certificates in a different order than the first certificate-recording computing node.

In some embodiments, the instructions stored in the memory of the first certificate-recording computing node, when executed, cause the one or more processors to: receive an incoming certificate associated with the first subnet; examine whether the incoming certificate is in conflict with the certificates stored in the certificate-recording computing node; and store the incoming certificate responsive to no conflict is identified.

In some embodiments, the proof of computational integrity of each certificate submitted by one of the subnets is a zero-knowledge proof.

In some embodiments, the plurality of certificates are stored in a partial order under a plurality of threads with a set of certificates associated with a particular subnet stored in a total order.

In some embodiments, the certificate-recording system is associated with a blockchain issuing a plurality of blockchain units, wherein the blockchain units are used as staking tools for a node to participate in the certificate-recording system.

In some embodiments, at last one of the certificates in the plurality of certificates includes: a state proof that a state of the first subnet is valid; a list of one or more cross-subnet messages initiated from the first subnet to one or more other subnets; and an inclusion proof that the list of one or more cross-subnet messages are included in the state of the first subnet.

In some embodiments, the proof of computational integrity in one of the certificates certifies validity of one or more operations in a state of the first subnet compared to a previous state.

In some embodiments, the cross-subnet operation includes the first subset performing: receiving a cross-subnet request from the second subnet; receiving one of the certificates of the second subnet from the certificate-recording system, the one of the certificates containing a proof of the cross-subnet request; verifying the proof in the one of the certificates; and executing the cross-subnet request based on the proof.

In some embodiments, the certificate-recording system is in communication with a plurality of subnets that perform operations, at least one of the subnets is configured to perform (1) in-subnet operations that are kept secret from other subnets that are in communication with the certificate-recording system and (2) cross-subnet operations through verifying one or more certificates stored in the certificate-recording system.

In some embodiments, a portion of the at least one of cross-subnet operations performed at the at least one of the subnets is kept secret from other subnets that are in communication with the certificate-recording system.

In some embodiments, the certificate-recording system is non-Turing-complete and consensusless.

In some embodiments, a non-transitory computer-readable medium that is configured to store instructions is described. The instructions, when executed by one or more processors, cause the one or more processors to perform a process that includes steps described in the above computer-implemented methods or described in any embodiments of this disclosure. In some embodiments, a system may include one or more processors and memory coupled to the processors that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. (FIG. 1 is a block diagram that illustrates a system environment of an interoperable cross subnet architecture system environment, in accordance with some embodiments.

FIG. 2 is a conceptual diagram illustrating how certificates may be stored and ordered in a certificate-recording system, in accordance with some embodiments.

FIG. 3 is a conceptual block diagram illustrating a forking situation of a subnet.

FIG. 4A is a conceptual diagram illustrating one or more cross-subnet operations, in accordance with some embodiments.

FIGS. 4B and 4C are sequence diagrams illustrating an example series of a cross-subnet operation carried out among components of the interoperable subnet system, in accordance with some embodiments.

FIG. 5A is a conceptual diagram illustrating an atomic composability feature of the interoperable subnet system within a subnet, in accordance with some embodiments.

FIG. 5B is a conceptual diagram illustrating an asynchronous composability feature of the interoperable subnet system, in accordance with some embodiments.

FIG. 5C is a conceptual diagram illustrating the concept of layered scalability, in accordance with some embodiments.

FIG. 6 is a block diagram that conceptually illustrates a data flow in inter-layer operability, in accordance with some embodiments.

FIG. 7A is a block diagram illustrating a chain of transactions broadcasted and recorded on a blockchain, in accordance with some embodiments.

FIG. 7B is a block diagram illustrating a connection of multiple blocks in a blockchain, in accordance with some embodiments.

FIG. 8 is a block diagram illustrating components of an example computing machine that is capable of reading instructions from a computer-readable medium and execute them in a processor (or controller).

The figures depict and the detail description describes various non-limiting embodiments for purposes of illustration only.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

In this disclosure, various example embodiments of an interoperable subnet system are discussed. An interoperable subnet system may provide a novel and inventive interoperability protocol that is truly trustless and decentralized while preserving the privacy of the participating networks. The interoperable subnet system allows cross-subnet messages to be safely exchanged without the need to rely on third parties to guarantee the validity of the cross-subnet messages. Instead, we showed that this trust can be replaced by proofs of computational integrity, providing cryptographic guarantees. Another benefit of using such proofs is that verification is extremely fast and barely grows with the size of the computation which grants great throughput increase capabilities. Furthermore, a novel threshold signature scheme is introduced to facilitate authentication of messages across the interoperable subnet system. Such primitive makes it practical to manage public keys as, unlike with other threshold signature schemes, the public key remains static for the whole lifespan of subnets. In addition, the certificate-recording system of the interoperable subnet system may implement a probabilistic reliable broadcast primitive to ensure consistent delivery of cross-subnet messages even in the presence of Byzantine actors. The primitive replaces the classical quorums in favor of stochastic samples while keeping the per-node communication and computation overhead very small even when the network size increases. This leads to a massively scalable and high throughput protocol.

Embodiments of the interoperable subnet system may provide secure, trustless, and decentralized interoperability protocols with the aim to realize the vision of an “Internet of Blockchains.”

### System Overview

FIG. (FIG. 1 is a block diagram that illustrates an environment 100 of an example interoperable cross-subnet architecture system, in accordance with some embodiments. By way of example, the system environment 100 includes an interoperable subnet system 110 that may include a subnet 112, a certificate interface 120, and a certificate-recording system 130. The system environment 100 may further include a computing server 140, a data store 150, a blockchain 160 that has one or more autonomous program protocols 162 stored on the blockchain 160, an organization 170, and a computing device 180. The entities and components in the system environment 100 communicate with each other through the network 190. In various embodiments, the system environment 100 may include different, fewer, or additional components. The components in the interoperable cross-subnet system environment 100 may each correspond to a separate and independent entity or may be controlled by the same entity. For example, in some embodiments, the computing server 140 may control the data store 150 but, in other embodiments, the computing server 140 and the data store 150 are operated by different entities. Likewise, the computing server 140 and the organization 170 can be different entities.

While each of the components in the system environment 100 may sometimes be described in the disclosure in a singular form, the system environment 100 may include one or more of each of the components. For example, there can be multiple computing devices 180 communicating with the computing server 140 and multiple subnets 112. The organization 170 may operate or participate in operating a subnet 112 and the system environment 100 may include multiple organizations. Also, the computing server 140 may provide service for multiple organizations 170, each of which may operate a subnet 112 and participate in the interoperable subnet system 110. While a component is described in a singular form in this disclosure, it should be understood that in various embodiments the component may have multiple instances. Hence, in the system environment 100, there can be one or more of each of the components. Likewise, while some of the components are described in a plural form may also only have a single instance in the system environment 100 in some embodiments. Also, various components in the system environment 100 may play overlapping roles. For example, a computing device 180 may serve as a node in a blockchain 160, a node in a subnet 112, and a node in the certificate-recording system 130.

The interoperable subnet system 110 is a system that implements an interoperability protocol to enable the exchange of messages and operations among various subnets 112 in the interoperable subnet system 110. A subnet 112 may perform operations that are completely within the subnet 112. This type of operation may be referred to as an in-subnet operation. Two or more subnets 112 may also perform cross-subnet operations through the interoperable subnet system 110. Depending on the interoperability protocol and certificates provided by the interoperable subnet system 110 in various embodiments, the cross-subnet operations may be performed without the participating subnets 112 trusting each other or revealing details of operations of those subnets 112. The cross-subnet operations may be performed by verifying one or more certificates stored in the certificate-recording system 130 in manners that will be discussed further below.

An operation may be any suitable operation carried out in one or more operations. Examples of operations include transactions (e.g., asset transactions), invoking a routine of a program protocol, exchanging messages between subnets, causing issuance of a token to a user, staking on a blockchain 160, and other operations, whether the operations are related to a blockchain 160 or not. Blockchain operations may include cryptocurrency or token transactions, invoking one or more algorithms of an autonomous program protocol 162, feeding data to an autonomous program protocol 162 through an oracle machine, performing mining or minting in a blockchain 160, staking in a blockchain 160 as a blockchain node, etc. In various situations, the term operations may be used interchangeably with the term transactions.

A subnet 112 in the interoperable subnet system 110 is a system that has implemented the interoperability protocol of the interoperable subnet system 110 so that the subnet 112 may perform cross-subnet operations under the interoperability protocol. A subnet 112 may take any suitable form. A typical example of a subnet 112 may be a blockchain 160 that is developed to include the interoperability protocol and the certificate interface 120. However, a subnet 112 may also take another form, such as a distributed application, a distributed system, or another group of devices performing transactions together. In some cases, one of the subnets 112 may also be a single general computing device that executes program operations, such as a computing device 180, and includes the interoperability protocol to conduct cross-subnet operations with another subnet 112. For simplicity, in this disclosure, a subnet 112 is often described as a blockchain, but other types of subnets 112 are also possible to be included in the interoperable subnet system 110. For a subnet 112 that is built as a blockchain 160, the subnet 112 may be Ethereum compatible. For example, the subnet 112 may be built using Ethereum programming languages such as Solidity or Ethereum Webassembly (EWASM).

In some embodiments, a subnet 112 may include a subnet computing node 114 and a virtual machine 116. In a distributed system, a subnet 112 may include multiple subnet computing nodes 114. A subnet computing node 114 may be a computing device 180 that provides the processors and memory for the virtual machine 116 to execute. While the subnets 112 may commonly implement the interoperability protocol of the interoperable subnet system 110 to allow cross-subnet operations, each designer of the subnet 112 may design the subnet 112 differently with various functionalities, purposes, and protocols. For example, various subnets 112 may be blockchains or non-blockchains, public or private, centralized or decentralized, and permissionless or not. One subnet 112 may offer a cryptocurrency exchange service. Another subnet 112 may be an in-game currency system that uses blockchain units as in-game units. Yet another subnet 112 may be a financial system that handles the authorization and authentication of transactions. Any system of any purpose may participate in the interoperable subnet system 110 as a subnet 112 by implementing the interoperability protocol of the interoperable subnet system 110. A subnet 112 can generate a proof of computational integrity of one or more operations.

In some embodiments, a subnet 112 may implement a virtual machine 116 that exposes a Turing complete programming language so that participants of the subnet 112 may perform operations based on the participants' designs. In some embodiments, a subnet 112 may also implement a zero-knowledge protocol, such as through the virtual machine 116, so that the operations (e.g., instructions executed) can be provable with zero-knowledge proofs. The zero-knowledge proof may be the proof of computational integrity that one or more operations that occurred in the subnet 112 are valid. A virtual machine 116 with the zero-knowledge proof protocol may be referred to as a zero-knowledge virtual machine (zkVM). Developers may use the zkVM programming language to write any type of applications which are deployed on a subnet 112 and whose executions are provable. The program applications may be conventional computer programs or autonomous program protocols such as smart contracts on a blockchain 160. The interoperability protocol implemented in a subnet 112 offers offer a set of instructions efficiently verifiable with a proof system of the interoperable subnet system 110. The interoperability protocol may also include into the default instruction set additional operation-specific instructions (e.g., range check, curve point addition, hash evaluation, etc.), to allow programmers to execute common operations directly without the burden of writing the instructions with the original instruction set.

The generation of a zero-knowledge proof is known in the art and the detail of the generation of a zero-knowledge proof is not part of this disclosure. For example, a zero-knowledge STARK proof may be used. Eli Ben-Sasson, Iddo Bentov, Yinon Horesh, and Michael Riabzev, entitled “Scalable, Transparent, and Post-Quantum Secure Computational Integrity,” IACR Cryptol. ePrint Arch., 2018:46, 2018, is incorporated by reference herein for all purposes.

The interoperability protocol of a subnet 112 may include protocols to execute a certificate interface 120. The certificate interface 120 may be a software layer, a virtual machine, or a separate distributed system, depending on the implementations of various systems. The certificate interface 120 implements a set of rules need to comply with for the generation of certificates. The certificate interface 120 may generate a digital certificate for one or more proofs of validity that are provided by a subnet 112. In some embodiments, interoperability protocol governs the generation of certificates and is shared among the subnets 112 in the interoperable subnet system 110. As such, the certificate interface 120 may also be referred to as a universal certificate interface (UCI) because the certificate interface 120 has a consistent protocol to generate certificates. The certificates generated by certificate interface 120 are verifiable by any subnets 112 without having the subnets 112 trust another subnet 112. The certificates may include only the proof of computational integrity but not actual information on the operations in a subnet 112. Two subnets 112 do not need to trust each other but can execute cross-subnet operations by verifying the certificates generated by the other subnet 112.

A certificate may certify the validity of one or more operations of a subnet 112. In some embodiments, a subnet 112 may operate in different states. Each state may include one or more operations. A certificate may be generated to verify the operations corresponding to the state. A second certificate may be linked to the previous state and verify one or more operations newly occurred in the current state compared to the previous state. A certificate may include a state proof that a state of the subnet 112 is valid, a list of one or more cross-subnet messages initiated from the subnet 112 to one or more other subnets, and an inclusion proof that the list of one or more cross-subnet messages are included in the state of the subnet 112. The certificate may include more information and the detail of example certificates and verification will be further discussed. In some embodiments, the digital signature of the certificate is generated by a group of participants of the subnet 112 using a digital signature scheme called ICE-FROST, which will be discussed further below. The scheme allows the participants to change but the group may continue to provide digital signatures with corresponding static public keys without a single party possessing the entire private cryptographic key. With static public keys, a group's established public and private keys remain the same for the lifetime of a subnet 112, while the signing shares of each participant are updated over time, as well as the set of group members.

The certificates of various subnets 112 generated from the certificate interface 120 are broadcasted and stored in the certificate-recording system 130. The certificate-recording system 130 may be a network of nodes that receives certificates submitted by subnets 112 and prevents subnets 112 from having conflicting certificates successfully processed. The certificate-recording system 130 may take the form of a decentralized system that allows participants to join the system and collectively store the certificates so that the certificates are trusted and verifiable. The certificate-recording system 130 may also be referred to as a transmission control engine (TCE).

In some embodiments, the certificate-recording system 130 may implement a permissionless probabilistic protocol of causal reliable broadcast. In some embodiments, this broadcast protocol does not involve consensus that enforces the total ordering of messages. Instead, the certificate-recording system 130 may use a causal ordering, e.g., certificates from the same subnet do not commute, while two independent certificates from two different subnets may commute. For examples, overall the certificates may be arranged in a partial order in different threads while certificates from the same subnet 112 may be arranged in a total order. The certificate-recording system 130 may be used to deal with the situation where a subnet 112 is under attack or is controlled by an adversary, and tries to double-spend. The certificate-recording system 130 examines whether an incoming certificate is in conflict with (e.g., being duplicative or having information conflicting) the certificates stored in the certificate-recording system 130. The certificate-recording system 130 stores the incoming certificate responsive to no conflict identified. Details of the operation and storing of certificates in certificate-recording system 130 will be discussed below.

The certificate-recording system 130 may take the form of a distributed system that is operated by multiple certificate-recording computing nodes. The distributed system may take different forms, whether it is public or private, permissionless or restricted, decentralized or centralized. For example, in some embodiments, the certificate-recording system 130 may be completely permissionless and allows any party in the public to participate as a node using a computing device. In some embodiments, the certificate-recording system 130 may allow any party to participate based on one or more simple conditions. For example, the certificate-recording system 130 may be associated with a blockchain 160 (e.g., a staking subnet) that issues a type of tokens that are possessed and traded by the participants of the certificate-recording system 130 as fees of the interoperable subnet system 110. For example, the blockchain 160 may issue the staking tokens by using a mint mechanism, a mining process, or a smart contract to generate additional quantities of the staking token. While blockchain 160 may allow any party to possess the tokens, the certificate-recording system 130 may impose staking requirements that a party may require a certain quantity of the token in the blockchain 160 to serve as a certificate-recording computing node in the certificate-recording system 130. In some embodiments, other ways to operate the certificate-recording system 130 are also possible. For example, in some cases, a certificate-recording system 130 for a particular type of interoperable subnet system 110 may be private.

The certificate-recording system 130 may store certificates in a partial order under a plurality of threads with a set of certificates associated with a particular subnet 112 stored in a total order. For example, for a particular subnet 112, the certificates of the subnet 112 may be stored linearly. Other sets of certificates for other subnets 112 may be stored in other liner threads. Since there are cross-subnet operations, the threads may be linked and certain certificates of different subnets 112 may be in causal orders. However, in some embodiments, no total order is enforced for all certificates, nor all of the certificates are arranged in a single and linear order. As such, in some embodiments, many certificates may be processed in a parallel fashion. Also, the processed order in a first certificate-recording computing node may be different from the order in a second certificate-recording computing node.

In some embodiments, the certificate-recording system 130 may preserve the privacy or secrecy of individual subnets 112 by storing certificates but not operation details of those subnets 112. For example, certificates may certify that the zero-knowledge proofs in the subnet 112 are valid but a certificate does not reveal any detail or sufficient detail to conduct an operation in a subnet 112. For example, a subnet 112 may perform in-subnet operations that are kept secret from other subnets that are in communication with the certificate-recording system and perform cross-subnet operations by verifying one or more certificates stored in the certificate-recording system. The portion of the cross-subnet operations in the subnet 112 may also be kept secret from other subnets. As such, a subnet 112 may not know much information about another subnet 112 but may still conduct a cross-subnet operation with the other subnet 112 by examining the certificates of the other subnet 112 certifying that the operations in the other subnet 112 are in fact valid.

In various embodiments, the features and functionalities of a certificate-recording system 130 may vary. For example, in some embodiments, the certificate-recording system 130 is not a blockchain. In some embodiments, the certificate-recording system 130 is concensusless. In some embodiments, the certificate-recording system 130 is non-Turing-complete and is used mainly for the storage of certificates without other significant processing capabilities. The features and functionalities of a certificate-recording system 130 in different embodiments allow a designer to balance performance, security and other factors in implementing an interoperable subnet system 110.

A computing server 140 may be a server that provides tools for organizations 170 to make subnets 112 that have the interoperability protocol built-in to participate in an interoperable subnet system 110. The tools may take the form of a software development kit (SDK), a programming library, and a platform (e.g., a software-as-a-service (SaaS) platform) for an organization 170 to design a subnet through the platform. The computing server 140 may also provide related services such as blockchain management service and other additional features for the functionalities of a subnet 112 to expand. For example, the computing server 140 may provide a SaaS platform for an organization 170 to configure an easy-to-build blockchain 160 as a subnet 112 that has the interoperability protocol to participate in the interoperable subnet system 110. The organization 170 may configure the parameters and settings of the subnet 112 through the SaaS platform. For other customers of the computing server 140, the engineers of the customers may decide to build a subnet 112 from scratch based on the SDK provided by the computing server 140. The computing server 140 may also set the standard and functionalities of the certificate interface 120 and the certificate-recording system 130. Developers can leverage the composability offered by the computing server 140 by composing applications with other zkVM-compatible applications deployed on any subnets 112 in the interoperable subnet system 110. In some embodiments, the subnets 112 built through the computing server 140 may also be compatible with other common industrial standards, such as supporting various Ethereum standards, ERC-20, ERC-721, ERC-1155, etc.

A subnet 112 may be managed directly by an organization 170 that operates the subnet 112 or by the computing server 140. For example, an organization 170, which builds the subnet 112 using the SDK provided by the computing server 140, may host the subnet 112. In other cases, an organization 170 may delegate the hosting and day-to-day running of subnet 112 to the computing server 140. For example, the organization 170 may configure a subnet 112 through the SaaS platform provided by the computing server 140. The computing server 140 may host the subnet 112 on behalf of the organization 170.

The computing server 140 may take various forms. The computing server 140 may also be referred to as a remote server. While the computing server 140 is referred to as a server, for simplicity, the computing server 140 may also encompass the company that operates the computing server 140. While the computing server 140 is described in a singular form, the computing server 140 may include one or more computers that operate independently, cooperatively, and/or distributedly. For example, in some embodiments, the computing server 140 may be a server computer that includes one or more processors and memory that stores code instructions that are executed by the one or more processors to perform various processes described herein. In some embodiments, the computing server 140 may be a pool of computing devices that may be located at the same geographical location (e.g., a server room) or be distributed geographically (e.g., clouding computing, distributed computing, or in a virtual server network). In some embodiments, the computing server 140 may be a collection of servers that independently, cooperatively, and/or distributedly provide various products and services described in this disclosure. The computing server 140 may also include one or more virtualization instances such as a container, a virtual machine, a virtual private server, a virtual kernel, or another suitable virtualization instance.

In some embodiments, the computing server 140 may provide a software marketplace (e.g., similar to an App store) through a digital distribution platform so that an organization 170 may add additional software components to the subnet 112 to expand the functionalities of the subnet 112. Various third parties may add their components, applets, SDKs, and other software to the marketplace for an organization 170 to select and add to the subnet 112 operated by the organization 170.

The data store 150 includes one or more storage units such as memory that takes the form of a non-transitory and non-volatile computer storage medium to store various data. The computer-readable storage medium is a medium that does not include a transitory medium such as a propagating signal or a carrier wave. The data store 150 may be used by the computing server 140 to store data related to the computing server 140, such as profiles of various organizations 170, parameters of various subnets 112 that are managed through the computing server 140, and other information related to the interoperable subnet system 110. In one embodiment, the data store 150 communicates with other components by the network 190. This type of data store 150 may be referred to as a cloud storage server. Examples of cloud storage service providers may include AMAZON AWS, DROPBOX, RACKSPACE CLOUD FILES, AZURE, GOOGLE CLOUD STORAGE, etc. In another embodiment, instead of a cloud storage server, the data store 150 is a storage device that is controlled and connected to the computing server 140. For example, the data store 150 may take the form of memory (e.g., hard drives, flash memory, discs, ROMs, etc.) used by the computing server 140 such as storage devices in a storage server room that is operated by the computing server 140.

A blockchain 160 may be a public blockchain that is decentralized, a private blockchain, a semi-public blockchain, an execution layer settling data on a public blockchain (e.g., Layer 2 blockchains, rollups), or an application-specific chain. A blockchain 160 may include a ledger that records transactions, code instructions, and other information associated with various blockchain addresses. A blockchain network includes a plurality of blockchain nodes that cooperate to verify transactions and generate new blocks. In some implementations of a blockchain, the generation of a new block may also be referred to as a proposal process that is based on a consensus mechanism, which may be a mining process (e.g., proof of work) or a validation process (e.g., proof of stake). A blockchain 160 may be a new blockchain or an existing blockchain such as BITCOIN, ETHEREUM, EOS, NEAR, SOLANA, AVALANCHE, etc. The system environment 100 may include one or more blockchains 160. A blockchain 160 includes a plurality of blockchain nodes. Each blockchain node may include one or more processors. The processors in various nodes may independently or cooperatively execute various blockchain processes such as generating blocks, reaching consensus, and executing code instructions that are stored on the blockchain 160.

In some embodiments, in the system environment 100, there can be different types of blockchains 160. For example, some blockchains 160 may be equipped with the interoperability protocol of the interoperable subnet system 110 and serve as the subsets 112 of the interoperable subnet system 110. Other blockchains 160 may be existing blockchains such as Ethereum, Bitcoin, etc. that may be outside of the interoperable subnet system 110. In some embodiments, a blockchain subnet 112 may be associated with an existing blockchain 160. For example, a blockchain subnet 112 may generate wrapped blockchain units that are equivalent to the native blockchain units in an existing blockchain such as Ethereum. The subnet 112 may issue a wrapped Ether that is equivalent to a single unit of Ether on Ethereum. The wrapped blockchain units in a subnet 112 may be used for cross-subnet operations such as in a transaction with another subnet 112 that wraps Bitcoin.

Some of the blockchains 160 support autonomous program protocol 162, which is a set of code instructions that are stored on a blockchain 160 and are executable when one or more conditions are met. Examples of autonomous program protocols 162 include token contracts, smart contracts, Web3 applications, autonomous applications, distributed applications, decentralized applications (dApps), decentralized finance (DeFi) applications, protocols for decentralized autonomous organizations (DAOs), protocols that generate non-fungible tokens (NFTs), decentralized exchanges, blockchain gaming, metaverse protocols, and other suitable protocols and algorithms that may be recorded on a blockchain. Smart contracts may be examples of autonomous program protocols 162 that may be executable by a computer such as a virtual machine 164 of the blockchain 160. Here, a computer may be a single operation unit in a conventional sense (e.g., a single personal computer), a resource of the blockchain such as a virtual machine 164, or a set of distributed computing devices that cooperate to execute the code instructions (e.g., a distributed computing system). An autonomous program protocol 162 includes a set of instructions. The instructions, when executed by one or more processors, cause one or more processors to perform steps specified in the instructions. The processors may correspond to a blockchain node of the blockchain 160 or may be distributed among various nodes of the blockchain 160.

Blockchain units may be any blockchain resources such as cryptocurrency, coins, or tokens that are generated and/or exchanged on a blockchain 160, such as BITCOIN, ETHER, TETHER, BINANCE COIN, US DOLLAR COIN, XRP, CARDANO, DOGECOIN, SOLANA, LITECOIN, etc. Blockchain resources may also include but are not limited to tokens, non-fungible tokens, fungible tokens, soulbound tokens, wrapped tokens, signed tokens, vault tokens, pool tokens, smart contracts, non-standard format on-chain available data or functions, nonstandard format on-chain discoverable data or functions and any variations of them. Blockchain resources can include but are not limited to on-chain available resources that refer to a blockchain address or a resource that is owned or controlled by a blockchain address. Other example units may include any fungible tokens that comply with the ERC-20 standard and non-fungible tokens such as those generated under ERC-721 standard.

A virtual machine 164 is a resource unit of a blockchain 160. A virtual machine 164 may be a standardized software execution environment that emulates the functionality of a physical machine and allows for the execution of autonomous program protocol 162 on the virtual machine 164. A virtual machine 164 may be run by any blockchain node. In some embodiments, a virtual machine 164 may take the form of a sandboxed environment that is created within the blockchain network to execute autonomous program protocol 162. The autonomous program protocols 162 are compiled into bytecode that can be executed by the virtual machine. One example of the virtual machine 164 Ethereum Virtual Machine (EVM) that executes the programming language Solidity. In some embodiments, a virtual machine 164 may operate based on binary instruction language such as Webassembly that can be executed in a variety of environments, such as web browsers. An example of such a virtual machine 164 is Ethereum WebAssembly (EWASM) which may allow programmers to build autonomous program protocols 162 using various common programming languages.

Blockchain operations may be any suitable operations related to blockchains 160 such as operations that are carried out on a blockchain 160 or an autonomous program protocol 162 of the blockchain 160. Examples of blockchain operations include cryptocurrency or token transactions, causing issuance of a token to a user, staking on a blockchain 160, invoking one or more algorithms of an autonomous program protocol 162, feeding data to an autonomous program protocol 162 through an oracle machine, performing mining or minting in a blockchain 160, participating in a blockchain 160 as a blockchain node, etc. In some embodiments, the phrase blockchain operations may be used interchangeably with the phrase blockchain transactions.

An organization 170, such as an enterprise, may be a customer of the computing server 140 and use different components and features offered by the computing server 140 to operate one or more subnets 112 in the interoperable subnet system 110. An organization 170 can be of any nature and participate in the interoperable subnet system 110 for different reasons. For example, an organization 170 may be part of a cryptocurrency exchange that may participate in the interoperable subnet system 110 to provide one or more subnets 112 to enable cross-blockchain transactions. Another organization 170 may be a financial institution that may leverage blockchain 160 and a subnet 112 to improve security, transparency, and efficiency in various processes by using the interoperable subnet system 110 and blockchain 160 for secure and faster cross-border payments, smart contracts for automated compliance, and decentralized identity verification. Another organization 170 may be a gaming company that may implement subnets 112 to create and manage in-game economies and virtual assets. By using tokens as in-game currencies on a blockchain 160, players have ownership and can trade their virtual assets securely. The virtual assets in different games may be exchangeable through the interoperable subnet system 110. Yet another organization 170 may be a supply chain management company that may utilize blockchain 160 to track and authenticate the movement of goods from the source to the end consumer and use the secure subnet 112 to conceal any business sensitive or confidential information in a supply chain while providing real-time visibility into the supply chain. Yet another organization 170 may be a healthcare company that streamline insurance claiming processing and other administrative process while securely storing patient and healthcare data in a subnet 112 without revealing any confidential information because the subnet 112 may be implemented as generating zero-knowledge proofs. Yet another organization 170 may be a real estate company that provide a transparent and tamper-proof record of property ownership, title transfers, and contract using blockchain 160 and the interoperable subnet system 110. Yet another organization 170 may be a voting system that allows blockchain-based voting to enhance the security and integrity of elections while may select the information that may need to be revealed through the certificate process of a subnet 112. These are intended to be non-limiting and non-exhaustive examples of organizations 170 that may participate in the interoperable subnet system 110.

An organization 170 may also be referred to as a domain. In some embodiments, the terms domain and organization may be used interchangeably. A domain refers to an environment for a group of units and individuals to operate and use domain knowledge to organize activities, enforce policies, and operate in a specific way. An example of a domain is an organization, such as a business, an institute, or a subpart thereof, and the data within it. A domain can be associated with a specific domain knowledge ontology, which could include representations, naming, definitions of categories, properties, logics, and relationships among various concepts, data, transactions, and entities that are related to the domain. The boundary of a domain may not completely overlap with the boundary of an organization. For example, a domain may be a subsidiary of a company. Various divisions or departments of the organization may have their own definitions, internal procedures, tasks, and entities. In other situations, multiple organizations may share the same domain.

Computing devices 180 may serve as various devices in running different components of the system environment 100. For example, a computing device 180 may serve as a computing node for a subnet 112, the certificate-recording system 130, the computing server 140, and/or a blockchain 160. A computing device 180 may simultaneously serve as different nodes for various distributed systems in the system environment 100. A computing device 180 may also be referred to as a client device or a user device. A computing device 180 may be controlled by a user who may be the user of the subnet 112, the computing server 140, or a blockchain 160, or an employee or administrator of the organization 170. In some situations, a user may also be referred to as an end user, for example, when the user is the organization's customer who uses a software application that is published by the organization 170 or who uses a subnet 112. In some situations, various users may be employees of the organization 170 and perform blockchain operations under the policies of the organization 170. The computing device 180 may be any computing device. Examples of computing devices 180 include personal computers (PC), desktop computers, laptop computers, tablet computers, smartphones, wearable electronic devices such as smartwatches, or any other suitable electronic devices.

In this disclosure, a node or a computing node may generally refer to a worker of a larger network (e.g., a distributed computing network) of computers that may work together to perform a task. A worker may take the form of a computing device, a virtual machine, or any computing component that has processing power, memory, and storage. A node may execute a task independently, distributedly, or cooperatively with other nodes. A blockchain node is a specific kind of node that participates in a blockchain network 160. A blockchain node may be a node that participates in the validation and processing of operations on the blockchain 160. Depending on the sub-type of a blockchain node, some blockchain nodes may store a copy of the entire blockchain ledger while other nodes may only store a partial copy of the ledger. In some embodiments, a subnet 112 may also be a distributed system that includes a number of nodes and the node may be referred to as a subnet computing node. Similarly, a certificate-recording system 130 may also include a plurality of nodes and the node may be referred to as a certificate-recording computing node.

A computing device 180 may include various applications 182 and corresponding user interfaces 184. In the system environment 100, multiple different types of applications 182 may be operated on a computing device 180. Those applications 182 may be published by different entities and be in communication with different components in the system environment 100. An application can be any software application such as various applications for subnets 112, an application (e.g., a SaaS platform) of the computing server 140 provided to an organization 170 to access services provided by the computing server 140, and an application associated with the use of a blockchain 160. By way of specific examples, in some embodiments, a first application 182 may be a software application that is published by the organization 170 for the employees of the organization 170 to perform work-related tasks. In some embodiments, a second application 182 may be a frontend application that is published by the computing server 140 (or managed by an organization 170) for a user to communicate with the subnet 112. In some embodiments, a third application 182 may be a software application for a user to communicate to a blockchain node for the user to gain information about a blockchain 160 or perform a blockchain operation. In some embodiments, a fourth application 182 may be a SaaS platform hosted by the computing server 140 as a web application for an administrator of an organization 170 to manage one or more subnets. These are merely examples of various types of applications 182 that may be operated on a computing device 180.

A user interface 184 may be the interface of an application 182 and allow the user to perform various actions associated with application 182. For example, application 182 may be a software application and the user interface 184 may be the frontend. The user interface 184 may take different forms. In one embodiment, the user interface 184 is a software application interface. For example, a business may provide a front-end software application that can be displayed on a computing device 180. In one case, the front-end software application is a software application that can be downloaded and installed on a computing device 180 via, for example, an application store (App store) of the computing device 180. In another case, the front-end software application takes the form of a webpage interface of the organization 170 that allows clients to perform actions through web browsers. The front-end software application includes a graphical user interface (GUI) that displays various information and graphical elements. For example, the GUI may be the web interface of a software-as-a-service (SaaS) platform that is rendered by a web browser. In some embodiments, user interface 184 does not include graphical elements but communicates with a server or a node via other suitable ways such as command windows or application program interfaces (APIs).

The communications among the components in the interoperable subnet system 110, the computing server 140, a blockchain 160, various computing devices 180, and the blockchain 160 may be transmitted via a network 190. The network 190 may be a public network such as the Internet. In one embodiment, the network 190 uses standard communications technologies and/or protocols. Thus, the network 190 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express Advanced Switching, etc. Similarly, the networking protocols used on the network 190 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 190 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 190 also includes links and packet switching networks such as the Internet.

### Example Features of an Interoperable Subnet System

Based on the architecture described in FIG. 1, an interoperable subnet system 110 may include one or more features as described below. In various embodiments, different versions of an interoperable subnet system 110 may include fewer, additional, different features that are explicitly described in this section.

In some embodiments, the interoperable subnet system 110 may exhibit a trustless feature. Subnets 112 receiving certificates and cross-subnet messages from another subnet 112 may enjoy guarantees as to the validity of these cross-subnet messages. These guarantees are not based on trust assumptions in centralized entities, decentralized actors, or the interoperated subnets 112, but on cryptographic assumptions. In some embodiments, leveraging succinct zero-knowledge proofs allows for removing trust among the subnets 112 and solely relying on mathematical truth.

In some embodiments, the interoperable subnet system 110 may exhibit as a secured system. The protocol described in this disclosure allows for robust security and prevents an adversary from creating conflicting certificates in an attempt to double-spend via cross-subnet messages. The protocol for checking conflicting certificates is further discussed below.

In some embodiments, the interoperable subnet system 110 may provide scalability. In some embodiments, the number of participants in the interoperable subnet system 110 is unlimited. An interoperable subnet system 110 may handle an arbitrarily large number of subnets, as well as to seamlessly scale to millions of participants of certificate-recording system 130, by providing logarithmic communication complexity per participant because the certificate-recording system 130 verifies the certificates instead of verifying the actual operations. The complexity of verifying the certificates simplifies the computations logarithmically. Furthermore, a certificate-recording system 130 also has a very high capacity to be able to process a massive number of cross-subnet messages.

In some embodiments, the interoperable subnet system 110 may also protect privacy. In some embodiments, if an operator of a subnet 112 chooses so, the subnet 112 may keep the internal state hidden from the rest of the system environment 100. The interoperable subnet system 110 does not need to rely on having the receiving subnet 112 nor any third-parties actively verify cross-subnet messages by accessing the state of the sending subnet 112. Instead, cross-subnet messages, through the certificates, may contain indisputable evidence that these messages are correct. The interoperable subnet system 110 may handle any type of subnets, e.g., public and private subnets.

In some embodiments, the interoperable subnet system 110 may also provide an authentication feature. The data exchanged between subnets 112 can be authenticated to provide guarantees of integrity. In some embodiments, authentication using threshold signatures should have a public key that remains static for the lifespan of subnets to facilitate key management. As such, it should be possible for any actors, inside and out of the interoperable subnet system 110, to verify the authenticity of cross-subnet messages.

In some embodiments, the interoperable subnet system 110 may also be decentralized. The interoperable subnet system 110 may allow for permissionless participation (or low requirement participation) in the certificate-recording system 130 and open registration of subnets 112. Participation does not need to be handled by a central authority, and processes should be able to join the system at any time. To enable high levels of decentralization, in some embodiments, the entry cost for participation remains low, such that common hardware is enough to fully participate in the system.

### Further Detail on Certificate, Signature, and Proof

This section provides further detail on the certificates, digital signatures and proofs of validity that may be used in an interoperable subnet system 110 using discussions of specific examples of components of an interoperable subnet system 110. In various embodiments, an interoperable subnet system 110 may include fewer, additional, or different components. Also, the use of specific terms and protocols in this section is merely examples and those with ordinary skills in the art would understand that the disclosure is not limited to the specific examples given.

The interoperability protocol of the interoperable subnet system 110 may take the form of a generalized interoperability protocol which enjoys a strong network effect. After a subnet 112 has implemented the interoperability protocol, the subnet 112 becomes interoperable with other subnets 112 in the interoperable subnet system 110. The interoperability protocol complies with one or more features and properties described in this disclosure, such as the previous section.

A subnet 112 may take the form of a sovereign blockchain network which implements the interoperability protocol, devise the subnet's own consensus rules, and control the subnet's own native asset. In some embodiments, subnets 112 join the interoperable subnet system 110 to be natively interoperable with existing subnets without making any compromise on their sovereignty and without the need to trust any middleman. In some embodiments, in addition to the interoperability protocol, subnets may also implement Byzantine fault tolerance (BFT) protocols to enforce deterministic finality. The BFT protocols may require the subnet 112 to guarantee that the state submitted to the rest of the interoperable subnet system 110 is finalized and cannot be reverted, hence avoiding the subnet 112 to be inconsistent between the subnet's internal state and the subnet's submissions.

In some embodiments, the computing server 140 may implement the first subnet 112 using a development kit, which may include one or more pre-built features according to existing frameworks such as SUBSTRATE or EDGE. In various embodiments, the framework used to be included in a development kit may vary based on design choice of the computing server 140. In some embodiments, the subnet 112 developed with the interoperability protocol may also include zkVM, which may serve as the execution environment for any autonomous program protocol 162 recorded on the blockchain subnet 112 in the system environment 100.

In some embodiments, subnets 112 may implement zkVM, a zero-knowledge virtual machine that exposes a Turing complete programming language which allows instructions to be provable with zero-knowledge proofs. Distributed application (dApp) developers can use the zkVM programming language (e.g., in Solidity or EWASM) to write any type of applications that are deployed on any subnets 112 in the form of autonomous program protocols 162 (e.g., smart contracts) whose executions are provable. Developers can as such leverage the composability offered by the interoperability protocol by composing their applications with other zkVM-compatible applications deployed on any subnets 112 in the system environment 100.

A set of proofing instructions executed by an zkVM may be efficiently verifiable a proof system. One example of the proof system may be referred to as zero knowledge Scalable Transparent Argument of Knowledge (zkSTARK), whose detail will be discussed below. The proofing instruction set, while small and simple, remains expressive enough for developers to easily write any kind of application on subnets 112. An zkVM may also include into the default instruction set additional operation-specific instructions (e.g., range check, curve point addition, hash evaluation, etc.), to allow programmers to execute common operations directly without the burden of writing them with the original instruction set. The interoperability protocol zkVM execution remains extremely fast to verify—maintaining the overall scalability of the system—even when extending the original instruction set with custom complex ones.

The interoperable subnet system 110 may also include a certificate interface 120, which may sometimes be referred to as a Universal Certification Interface (UCI). The certificate interface 120 enfolds the concept of proving and verifying data across different subnets 112. By using the certificate mechanism provided by the certificate interface 120, a sending subnet 112 generates data intended for another subnet 112 and the receiving subnet 112 is ensured that the data is valid and authentic without the need for trust in the sending subnet 112 or any third party. The certificate interface 120 may take the form of an abstraction of the internal structure of a subnet 112 to guarantee the properties of validity and authentication without compromising the sovereignty and privacy of the sending subnet 112.

In the system environment 100, the certificate interface 120 exposes the interface that all subnets 112 implement in order to be interoperable with each other, e.g., exchange certified data. The certificate interface 120 may control how certificates are to be constructed and authenticated by subnets 112.

In some embodiments, a certificate is an authenticated object that wraps exchanged data with a proof of computational integrity. The data that subnets 112 exchange may take the form of cross-subnet messages, e.g., cross-subnet asset transfers or remote arbitrary smart contract calls. Authentication of certificates is done with the interoperability protocol's digital signature scheme and proofs of valid state transition are created using the zkSTARK proof system. An example of the digital signature scheme may be referred to as ICE-FROST signature, whose detail will be discussed below.

An example of certificate may include the following elements:
subnet_id is the static ICE-FROST public key used as the unique subnet identifier;
prev_state_hash is the previous subnet state commitment (from the previous certificate);
state_hash is the current subnet state commitment;
proof is the zkSTARK proof of computational integrity;
XS_list represents the list of included cross-subnet messages;
proof_XS_list is the list of inclusion proofs of cross-subnet messages in the proven state transition.

By including proofs of valid state transition in certificates, a sending subnet 112 may prove the validity of the internal operations executed by the sending subnet 112 since the previous certificate of the sending subnet 112. Some of the internal operations may include portion of cross-subnet messages that are executed by the sending subnet 112. This allows a receiving subnet 112 (e.g., a subnet 112 to which at least one cross-subnet 112 message contained in the certificate is addressed) to verify the validity of a message without having access to the state of the sending subnet 112 nor relying on a third party to verify the complete state transition.

In some embodiments, a valid state transition is defined as follows: Definition (Valid State Transition): Let STF: [symbol] ₖ× [symbol] ₖ₊₁→ [symbol] ₖ₊₁ be a state transition function, where [symbol] ₖ is the k-th subnet state committed to in the k-th certificate, and [symbol] ₖ₊₁ is a set of operations which applied to [symbol] ₖ results in [symbol] ₖ₊₁. In some embodiments, a state transition is valid if and only if: ∀tx∈ [symbol] ₖ₊₁, tx is an operation correctly executed by the subnet 112. In some embodiments, the valid state transaction condition may be relaxed compared to the above definition.

The zkSTARK proof included in the certificate verifies that the set of operations [symbol] ₖ₊₁ between Certₖ and Certₖ₊₁ is a valid state transition. While this does not ensure the validity of the subnet state, it guarantees the validity of the subnet's state transitions. If the state initially committed to by the subnet 112 as per subnet's registration and all of the subnet's subsequent state transitions are valid, then by transitivity the subnet's latest state is valid.

The certificate validation is handled by the Valid_cert predicate, defined in algorithm 1 below, which calls the zkSTARK Verif_{C} predicate (see Equation 1) on the certificate data to assert the validity of the committed state transition, checks the inclusion proofs of the cross-subnet messages in the proven state transition, and returns true if both checks succeed. In this case, the predicate provides the certificate with intrinsic validity: The certificate contains the necessary information to prove its validity and the certificate's verification does not depend on an external state—the predicate is stateless and so trivially monotonic.

Algorithm 1 Certificate validation predicate

```
function Valid_cert(Cert)
  return Verif_{C}(Cert.proof, Cert.prev_state_hash, Cert.state_hash) ∧
    Verify_incl(Cert.proof_XS_list)
end function
```

An ICE-FROST signature may be a digital signature scheme that is used by the certificate interface 120 for generating certificates. In some embodiments, a signature scheme, TS=(KeyGen, Sign, Verify), may include with key generation, signing, and verification algorithms KeyGen, Sign, and Verify respectively. A security parameter λ. is a (t, n) threshold signature scheme if the following conditions hold:
Correctness. Any subsets of participants with cardinality at least t can produce a valid signature on message m. A valid signature is a signature that will be verified by the Verify algorithm.
Unforgeability. Any polynomial-time adversary who can corrupt up to t−1 players and view the protocol output (signature) on poly(λ) input messages of the adversary's choice cannot produce the valid signature σ for a message m that has not been submitted to the Sign algorithm before.

In some embodiments, the interoperability protocol may employ threshold signatures to authenticate certificates, e.g., allow actors of the interoperable subnet system 110 to verify that a propagated certificate has been created by the correct subnet 112 and has not been tampered with in transit. The ICE-FROST signature is the first to consider static private/public keys for a round-optimized Schnorr-based signature scheme. In some embodiments, other linear and non-malleable signature scheme may be used. In some embodiments, other signature algorithms such as Digital Signature Algorithm (DSA) and the Elliptic Curve Digital Signature Algorithm (ECDSA) may be used. In ICE-FROST, with static public keys, a group's established public and private keys remain the same for the lifetime of a subnet 112, while the signing shares of each participant are updated over time, as well as the set of group members. The group may be a set of subnet computing nodes in this example and a participant or a validator of the subnet 112 may be a subnet computing node. The use of ICE-FROST allows the long-term security of the static keys and facilitates the verification process of the generated threshold signature because a group of signers communicate their public key to the verifier only once during the subnet's lifetime. Alonso Gonzalez, Hamy Ratoanina, Robin Salen, Setareh Sharifian, and Vladimir Soukharev, Entitled “Identifiable Cheating Entity Flexible Round-Optimized Schnorr Threshold (ICE FROST) Signature Protocol,” Cryptology ePrint Archive, Report 2021/1658, 2021, is incorporated by reference herein for all purposes.

In some embodiments, dealerless threshold signature schemes usually need to run a distributed key generation protocol each and every time the set of participants changes, resulting in a new public key. However, the usage of the certificate-recording system 130 may require knowing the public key associated with a signature of a certificated recorded in order for the participants of the certificate-recording system 130 to verify the signature. A natural approach would be to include the threshold signature public key for the next certificate in the current certificate but such short-lived public keys clearly lead to large overhead and are not suited for the interoperability protocol. In some embodiments, a novel and inventive aspect of the interoperable subnet system 110 includes using threshold signatures to make long-lived static public keys possible. In some embodiments, the interoperability protocol uses ICE-FROST to enforce usage of a single static public key (or only a few static public keys) for the whole lifespan of the subnet 112, no matter how many times the set of validators of the subnet 112 changes. This allows for a lighter and simpler key management for a subnet 112.

In some embodiments, in order to use a long-lived public key for each subnet 112, the certificate interface 120 for a subnet 112 may include a share update property. The share update property may also be referred to as a key shards. Each validator in a given set has a different key shard. The key shards collectively form a private cryptographic key, through known mechanisms such as multi-party computation. When the validator set changes, the key shards may be re-generated and re-shared among the new validators. By way of example, to update the shares of the private cryptographic key for each validator set, participants secretly share the value “0” (or another appropriate value) and send corresponding shares to other participants. These new shares are added to previous shares to randomize them without changing the value of the shared secret. Randomization of shares guarantees unforgeability of the threshold signature scheme against a static adversary, e.g., an adversary who can corrupt up to t−1 participants. A dynamic adversary on the other hand can corrupt different t−1 participants in each validator set. Because validators' secret shares need to be encrypted when redistributed, an additional property of forward secrecy is also included. For example, an attacker that would get access to some validator decryption key would only be able to derive decryption keys between this compromised validator and future ones, but would not be able to decrypt messages encrypted and shared by previous validator sets during the shares redistribution phase, and hence would not gain knowledge of additional secret shares. This key property ensures that even if the adversary corrupts different subsets of participants in consecutive validator sets, they still cannot forge a valid signature.

In some embodiments, a certificate generated by the certificate interface 120 and stored in the certificate-recording system 130 may include one or more proofs of validity of operations of a subnet 112. In some embodiments, a proof of computational integrity may be referred to as Scalable Transparent Argument of Knowledge (STARK) proof. STARKs are based on the concept of an argument of knowledge, where a prover demonstrates knowledge of a specific solution or outcome without revealing any further information. In some embodiments, STARKS are used to prove that a computation was executed correctly without revealing the underlying data or algorithm. When a subnet 112 submits a certificate, the subnet 112 commits to a new state and certifies the state transition. The new state is the state committed to in the previous certificate on which the state transition is applied. To convince other subnets 112 that the state transition is valid and consistent with the previous state, the certificate contains a proof of computational integrity, a zkSTARK proof.

A STARK proof guarantees that a computation has been correctly executed and has returned a certain output, and (if needed) without revealing the input. For example, a STARK proof can guarantee one or more of the following:
The state [symbol] ₖ₊₁ is the state [symbol] ₖ plus some transactions, without revealing the transactions;
The hash of the state [symbol] ₖ₊₁ is the hash of the state [symbol] ₖ plus some transactions, without revealing the transactions nor the states; and/or
An Account a on subnet 112 [symbol] ᵢ made a valid (holds enough funds and signed) transfer of x tokens to an account b on subnet 112 [symbol] ⱼ, without revealing the balance of a.

More formally, a STARK proof is sent by a prover [symbol] to convince a verifier [symbol] that the prover [symbol] ran a certain computation C with some input I (and possibly obtained some output [symbol] ). The STARK system is made of a proving algorithm and a verifying algorithm. While [symbol] is known to both P and [symbol] , I and [symbol] could be partially or fully kept secret by the prover [symbol] or shared between the prover [symbol] and the verifier [symbol] , depending on the statement to be proven. In some embodiments, below is an example process which may take four steps:
1. [symbol] runs [symbol] with input I and records an execution trace t. Broadly speaking, the trace is a 2D-matrix recording the value of all the variables of [symbol] at each execution step. [symbol] also saves the output [symbol] if any.
2. [symbol] executes the proving algorithm Prov_{C} on input t (and [symbol] if any), which returns a STARK proof π that [symbol] has been correctly executed with some input, and returned [symbol] as an output (if any).
3. [symbol] sends π (and possibly parts of I, [symbol] , or functions of them, depending on the statement) to [symbol] .
4. [symbol] executes Verif_{C} on input the proof and potential inputs/outputs received. It returns true if the proof has been computed from a valid execution of [symbol] that returns [symbol] (if any) on input I, and False otherwise.

STARK systems are known to be scalable, with a prover [symbol] that is running in time O(t log² t) for the computation, dominated by the Fast-Fourier-Transform interpolation, and a verifier [symbol] that scales in only poly-logarithmic time with the trace length, e.g., O(log² t). The prover [symbol] and verifier [symbol] can be nodes within a subnet 112 when a certificate is generated. The prover [symbol] and verifier [symbol] can also be a first subnet 112 that has transmitted a certificate and a second subnet 112 that is attempting to verify the certificate. The simplification in complexity for the verifier [symbol] allows verifier subnets 112 to prove exponentially large computations and hence improve the overall scalability of the interoperability protocol. In addition, the certificates in interoperable subnet system 110 using STARK are post-quantum secure, as the certificate rely on symmetric primitives such as hash functions, unlike other cryptographic methods that may be based on asymmetric primitives. In some embodiments, the certificates may further use asymmetric primitives in addition to the STARK proofs.

In some embodiments, the interoperability protocol may need a distinct pair of proving and verifying algorithms for each specific operation because process discussed above may have an issue that that Prov_{C} and Verif_{C} both depend on [symbol] . Not only does it require both participants to potentially store and execute multiple algorithms, but it also forces [symbol] to write a specific proving algorithm for every new computation, for example for a new smart contract, it wants to prove. [symbol] would likewise need to make sure to keep its verifying algorithm up to date. For these reasons, the interoperability protocol in the interoperable subnet system 110 may include a general-purpose approach. The STARK system in the interoperable subnet system 110 can prove arbitrary computations with a single pair of proving and verifying algorithms that do not need to be updated if the program to prove is modified.

More precisely, the computation [symbol] which is proven is the interoperability protocol zkVM execution itself. I consists in a state_hash and all the operations happening on-chain modifying this state. [symbol] is the final state being returned by the interoperability protocol zkVM after applying the provided input state transition on the input state. After a proof has been computed, [symbol] sends it to [symbol] , along with a hash of the final state [symbol] . The hash of the previous state can be retrieved from the latest verified certificate of the subnet 112 [symbol] belongs to. Only providing the state hashes allows sending subnets 112 to keep their state private and improves on scalability by reducing the overhead in data transmitted. The verification function is defined by Equation (1) as follows:

$${Verif}_{c} ( {π}_{k} , Hash ( {𝒮}_{{k}^{- 1}} ) , Hash ( {𝒮}_{k} ) ) = \{ \begin{matrix}true , & iftheproofisvalid \\ false , & otherwise\end{matrix} \qquad ( 1 )$$

The verification function attests to the validity of the state transition claimed by a sending subnet 112, from a previous state that was committed to (in the form of a hash), to a new committed state. This algorithm outputs true if the prover submitted a valid state transition as part of its (private) input I, e.g., corresponding to valid executions of the interoperability protocol zkVM.

Since the interoperability protocol relies on cryptography for subnets 112 to prove the validity of their state transitions to the rest of the interoperable subnet system 110, efficient cryptographic primitives are used in order to preserve high scalability. STARK proof systems—in particular the ones based on FRI, as is the case for the one used in the interoperability protocol of the interoperable subnet system 110—have very light requirements (namely to work on a prime field [symbol] ₚ with a 2^{k}-th root of unity for relatively large k) whereas other common Succinct Non-interactive Argument of Knowledge (SNARK) constructions are based, among other things, over algebraic groups, which involve complex mathematical operations that can be hard to implement and optimize. In particular, the prime field involved in STARK proof systems can be much smaller than the usual cryptographic size of 256 or 512 bits. However, blockchains 160 often require some digital signature scheme to assert the authenticity of propagated messages and, to date, digital signatures based on elliptic curves, such as Schnorr signatures, EdDSA or ECDSA are the preferred ones, due to both those protocols' speed and resulting size. The underlying curves commonly used in pair with those schemes are all of large cryptographic sizes, and hence prevent from benefiting fully from the mathematical structure of our proving system. To address this, and to offer subnets the possibility to exploit the whole power of STARKs, in some embodiments, the interoperability protocol of the interoperable subnet system 110 may use a new elliptic curve constructed over a sextic extension of a small field with characteristic p=2⁶⁴−2³²+1 and tailored for efficiency when proving operations over its group. A detailed security analysis and description of the deterministic process that generated this curve is available at Robin Salen, Vijaykumar Singh, and Vladimir Soukharev, entitled “Security Analysis of Elliptic Curves over Sextic Extension of Small Prime Fields,” Cryptology ePrint Archive, Report 2022/277, 2022. The interoperability protocol zkVM execution [symbol] of the interoperable subnet system 110 can be proven while maintaining a small proof system base field.

The STARK system at the core of the interoperability protocol may include one or more of the follow features.
Trustless: The soundness property of STARKs ensures that it is computationally infeasible for a malicious prover to create a valid proof for an invalid statement. This means that validity of state transitions solely depends on the soundness of the STARK proof included in certificates.
Private: Instead of providing the whole computation that updated their internal state to the verification function, subnets pass only the known hash of their previous state along with the hash of their new state, thus do not reveal anything about transactional data. The computational integrity ensured by the STARK proof system combined with zero-knowledge guarantees that no additional information about the state of subnets is revealed to verifiers; this grants full privacy to subnets.
Scalable: STARKs can prove the computational integrity of a very large number of transactions while keeping the verification cost extremely small.

### Examples of a Staking Subnet

In some embodiments, the interoperable subnet system 110 may be associated with a staking subnet, which may be a blockchain 160. The staking subnet is a blockchain network whose main purpose is to handle registration of the interoperable subnet system 110 actors, such as the subnets 112 and the participants (e.g., the nodes) of the certificate-recording system 130, to manage the interoperable subnet system 110, to manage the native cryptocurrency (e.g., named TOPOS but can be in any name) of the interoperable subnet system 110, and to allow for governance of the interoperability protocol of the interoperable subnet system 110 through on-chain voting. For example, the token holders of the staking subnet may have the ability to participate in future protocol improvements. Subnets 112 may register the subnets 112 by sending a special transaction which pays a dedicated fee denominated in TOPOS. In some embodiments, the staking subnet is leveraged for the Sybil resistance of the certificate-recording system 130, requiring participants to lock a TOPOS amount (staking requirement) in order to join the certificate-recording system 130. Finally, the staking subnet enables the setup of an incentive mechanism for the participants of the certificate-recording system 130 to be rewarded when following the prescribed protocol.

By way of example, an example of staking subnet may be built with the Substrate framework and implements any suitable consensus mechanism such as the hybrid BABE/GRANDPA consensus. Block production is conducted by the Ouroboros Praos-based BABE protocol. BABE ensures liveness which guarantees that transactions submitted by honest users will eventually be recorded as part of the interoperability protocol Subnet state. Moreover, GRANDPA is leveraged as the finality gadget to ensure deterministic finality guaranteeing that blocks can never be reverted once finalized unlike protocols where finality is only probabilistic. Through the process of nomination and validation, an unbounded number of TOPOS token holders are economically incentivized to participate in the consensus and contribute to the security of the system.

In some embodiments, the staking subnet may be used for the following key operations: (i) subnets registration to the interoperable subnet system 110; (ii) management of the participation in the certificate-recording system 130; and (iii) TOPOS asset management. Even if the security of the interoperable subnet system 110 does not fully lean on the staking subnet, the failure of the staking subnet could incur potential vulnerabilities in the interoperable subnet system 110. In some embodiments, the interoperable subnet system 110 may be implemented without relying on a dedicated staking subnet. This means that the three key operations described may be implemented at the TCE level (certificate-recording system 130). Intuitively, all the information totally ordered in the staking subnet would need to be replicated at the TCE level, and in absence of consensus this information would appear in different order to different TCE nodes. However, in some embodiments partial ordering of sets of messages is sufficient to implement all three operations. Indeed, all these operations may be dependent on a token and causal reliable broadcast (that the TCE implements) is sufficient to implement a cryptocurrency, even in the case where the reliable broadcast protocol implements an inflation mechanism. In some embodiments, the features and functionalities of the staking subnet may be implemented as a certificate-recording system 130, whether it is the same certificate-recording system 130 used in the interoperable subnet system 110 or a different certificate-recording system 130. In some embodiment, the certificate-recording system 130 may include one or more features of the blockchain 160.

### Examples of Certificate-Recording System

This section provides additional non-limiting detail and examples of a certificate-recording system 130, which may also be referred to as the Transmission Control Engine (TCE). The certificate interface 120 ensures that subnets' state transitions are valid (guaranteed by the STARK proof) and that the certificates transporting them are authenticated (guaranteed by the ICE-FROST signature). To allow for trustless cross-subnet communication, subnets 112 additionally rely on the certificate-recording system 130, a network of nodes that receives certificates submitted by subnets to consistently deliver them, e.g., prevent subnets 112 from having conflicting certificates successfully processed.

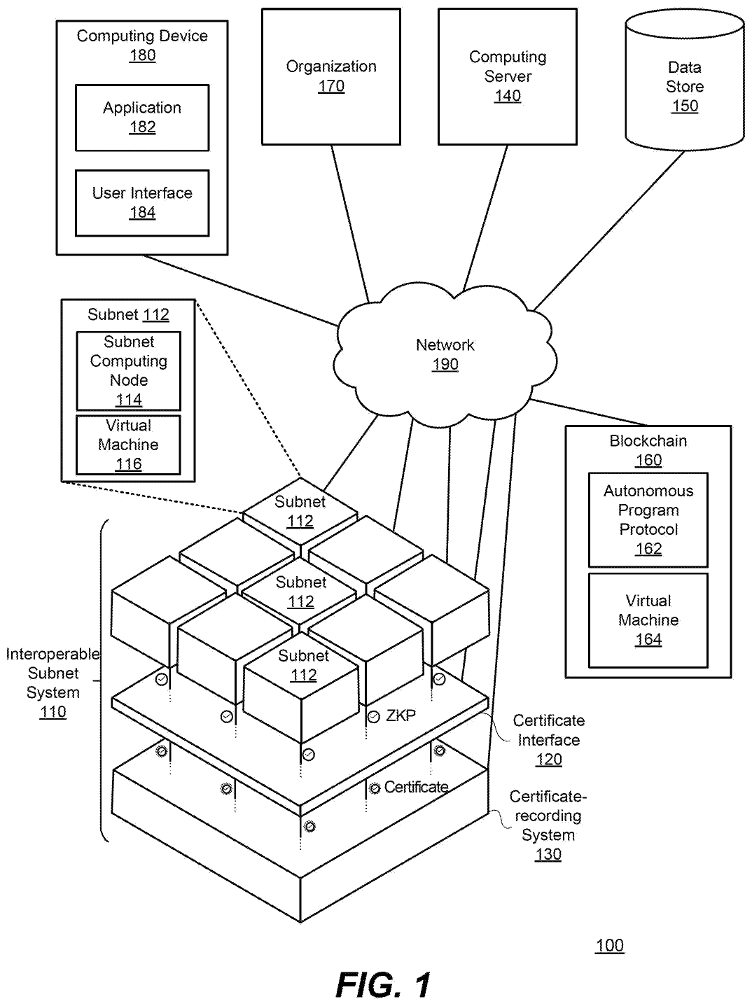

FIG. 2 is a conceptual diagram illustrating how certificates may be stored and ordered in a certificate-recording system 130, in accordance with some embodiments. In FIG. 2, the processes p₁ and p₂ maintain the same set of certificates that are ordered differently.

In some embodiments, certificate-recording system 130 may implement a permissionless probabilistic protocol of causal reliable broadcast. In some embodiments, the probabilistic protocol does not involve consensus since consensus enforces total ordering on messages while the certificate-recording system 130 may implement causal ordering. For example, certificates from the same subnet 112 do not commute, while two independent certificates from two different subnets may commute. Referring to FIG. 2, causal ordering is illustrated so that the certificate-recording system 130 may process all dependencies of a specific. Using causal ordering results in a simpler, more efficient and more robust protocol than consensus-based solutions.

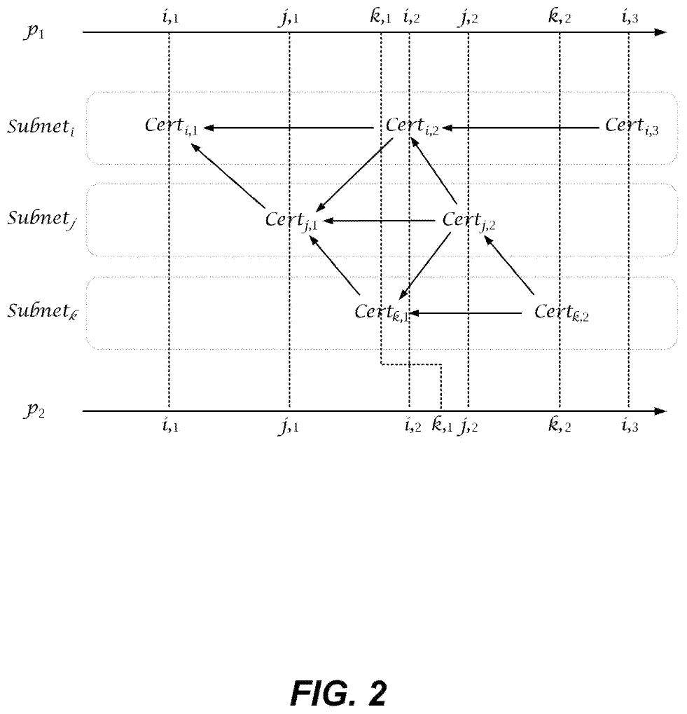

In some embodiment, an example role of the certificate-recording system 130 is to deal with the situation where a subnet 112 is under attack or is controlled by an adversary, and tries to double-spend. A subnet Sₘ controlled by an adversary may send the same assets twice to different subnets Sᵢ and Sⱼ, e.g., Sₘ broadcasts two conflicting n-th certificates (Certₙ to Sᵢ and Cert_{n′} to Sⱼ) using the certificate interface 120. FIG. 3 is a conceptual block diagram illustrating a forking situation of a subnet 112. As shown in FIG. 3, the two certificates Certₙ and Cert_{n′} are said to be conflicting if both Certₙ and Cert_{n′} are valid with respect to Certₙ₋₁ but the operations associated with the two certificates do not have a valid sequential history. The certificate-recording system 130 includes an anti-conflicting protocol to prevent conflicting certificates, so that Sᵢ and Sⱼ would not be independently execute messages on-chain from Certₙ and Cert_{n′} respectively while the Certₙ and Cert_{n′} are conflicting, signifying that Sₘ may be trying to double-spend.

The certificate-recording system 130 may include a reliable broadcast protocol. For a set Π of n processes, those processes are equipped with private and public keys and identified with the public keys. At most a fraction f of all processes is Byzantine, e.g., subject to arbitrary failures. A process is correct if the process follows the prescribed protocol. Byzantine processes cannot determine which correct process and another correct process are communicating with each other. Byzantine processes are under the control of the same adversary, and can take coordinated actions.

Processes can communicate with each other using the Probabilistic Reliable Broadcast (PRB) primitive. An instance of probabilistic reliable broadcast exports two events:
prb.Broadcast(m): Used by a process inside the system to broadcast a message m;
prb.Deliver(p, m): Used by a process inside the system to handle the delivery of a message m from sender p.

Note that in this disclosure, prb.Broadcast and prb.Deliver may be used as verbs and adjectives, such as a node “prb.Broadcasts” a message, or a message is prb.Delivered.”

In some embodiments, for any ϵ∈[0, 1], the certificate-recording system 130 may define that a protocol implementing the reliable broadcast is ϵ-secure if the following properties hold:
No duplication: No correct process prb.Delivers more than one message.
Integrity: If a correct process prb.Delivers a message m, and the sender p is correct, then m was previously prb.Broadcast by p.
ϵ-Validity: If the sender p is correct, and p prb.Broadcasts a message m, then p eventually prb.Delivers m with probability at least (1−ϵ).
ϵ-Consistency: Every correct process that prb.Delivers a message prb.Delivers the same message with probability at least (1−ϵ).
ϵ-Totality: If a correct process prb.Delivers a message, then every correct process eventually prb.Delivers a message with probability at least (1−ϵ).

In some embodiments, the probabilistic reliable broadcast protocol of the certificate-recording system 130 may be asynchronous, permissionless and tolerant to Byzantine (arbitrary) failures. The probabilistic reliable broadcast protocol replaces classical quorums by stochastic samples which do not need to intersect and are of much smaller size compared to quorums. The probabilistic reliable broadcast protocol has O(log n) message complexity per process—thus an overall message complexity of O(n log n)—and the sample size per process is logarithmic in the size of the system which hints at its massive scalability capabilities. The properties of Byzantine reliable broadcast of the certificate-recording system 130 can be violated with probability ϵ, which can be made arbitrarily small.

The probabilistic reliable broadcast protocol may include three sequential phases of communication exchanges, namely, subscriptions, Echo exchanges, and Ready exchanges. Upon initialization, a correct process randomly samples three sets via a uniform random oracle. The size of each set and the associated threshold are security parameters of the protocol. At the end of the initialization, each correct processes has the following:
An Echo sample [symbol] and its associated threshold E<| [symbol] |
A Ready sample [symbol] and its associated threshold R<| [symbol] |
A Delivery sample [symbol] and its associated threshold D<| [symbol] |

During the subscription phase, a process starts exchanging sample-specific subscription messages with processes in the Echo, Ready and Delivery sets. Upon receiving sample-specific subscription messages from other processes, a process adds the corresponding message senders in new samples in the following manner:
Senders of Echo subscription messages are added to a new [symbol] set.
Senders of Ready subscription messages are added to a new [symbol] set;

These sets determine how processes communicate between them. A process interacts with its sets as follows:
It only listens for messages coming from peers in ∇, ⊕andΓ, sets;
It only sends messages to peers in [symbol] and [symbol] sets.

In some embodiments, each set is such that its size is Ω(log n).

In some embodiments, an algorithm implementing the probabilistic reliable broadcast may include the following properties. Processes can communicate directly with each other or broadcast messages using a probabilistic (not necessarily reliable) broadcast primitive, which might deliver conflicting copies of a message. In the following we refer to the messaging process as pb.Broadcast and pb.Delivery. Upon the invocation of prb.Broadcast for a message m, a process p executes the broadcast function pb.Broadcasts to broadcast the message to all the processes in Π. After completing pb.Delivery, a correctly signed message m is generated. A correct process sends an Echo message to every process in the [symbol] subscription set.

A correct process sends a Ready message for m (if correctly signed) to all processes in its [symbol] subscription set if the process receives either:
at least E Echo messages for m from [symbol] ; or
at least [symbol] Ready messages for m from [symbol] .

When a correct process receives more than D Ready messages for m from its delivery sample [symbol] for the first time, and m is correctly signed, the condition of delivery of message m, prb.Delivery, is satisfied.

In some embodiments, in the context of the interoperability protocol of the interoperable subnet system 110, the protocol may include additional safeguards on top of the probabilistic reliable broadcast. For example, the certificate-recording system 130 is meant to consistently deliver messages while preserving causal order among the messages. A weak causal order may be implemented to modify the PRB solution to extend the solution with a weak causal order property. The certificate-recording system 130 may employ Weak Causal Probabilistic Reliable Broadcast to broadcast certificates across the network, and the nodes of the certificate-recording system 130 update states of the nodes accordingly. The detail of the weak causal order and node state update will be discussed in the next two sections below.

### Weak Causal Probabilistic Reliable Broadcast

In some embodiments, a Weak Causal Probabilistic Reliable Broadcast (wcprb) extends the previous broadcast primitive with an additional weak property of causal order among the delivered messages. Intuitively, the weak causal order property imposes that, if a correct process delivers a message m, then m is weakly causally ordered with respect to the previously delivered messages. In some embodiments, a definition of causal precedence is implemented in a certificate-recording system 130.

Definition (Causal Precedence): Let a step be the broadcast or the delivery of a message. A given set of steps induces a partial order as follows. Step a casually precedes step b, denoted a→b, if and only if:
the same process executes both a and b, in that order; or
a is the broadcast of some message m and b is the delivery of m; or
there is a step c, such that a→c and c→b.

The communication of the certificate-recording system 130 may execute a certain order that has rules that are more relaxed than the causal precedence definition. Intuitively, a certificate-recording system 130 is interested in keeping the execution order among the messages wcprb.Broadcast by the same process on behalf of a subnet. The certificate-recording system 130 may also impose the same execution order for any pair of wcprb.Delivered and wcprb.Broadcast messages by the same process. However, it may not be necessary for the certificate-recording system 130 to keep the execution order among messages wcprb.Delivered between two wcprb.Broadcasts from the same subnet, e.g., certificates in deps. For instance, as shown in FIG. 2, correct processes p₁ and p₂ can wcprb.Deliver Cert_{k,1} and Cert_{i,2} in different orders.

To formalize the above rules, the certificate-recording system 130 may implement a weak causal precedence relation, defined as follows:

Definition (Weak Causal Precedence). Let a step be the broadcast or the delivery of a message. A given set of steps induces a partial order as follows. Step a weakly casually precedes step b, denoted a→_{w} b, if and only if:
the same process executes both a and b, in that order, such that a and b are not a delivery step; or
a is the broadcast of some message m and b is the delivery of m; or
there is a step c, such that a→_{w} c and c→_{w} b.

An instance of Weak Causal Probabilistic Reliable Broadcast (wcprb or WCPRB) may expose two events:
wcprb.Broadcast(m): Used by a process inside the system to broadcast a message m;
wcprb.Deliver(m): Used by a process inside the system to deliver a message m.

For any ϵ∈[0, 1] we say that the protocol implementing the WCPRB is ϵ-secure if the following properties hold: No duplication, Integrity, ϵ-Validity, ϵ-Consistency, ϵ-Totality as defined for the probabilistic reliable broadcast, and additionally:
Weak causal order: If the wcprb.Broadcast of a message m weakly causally precedes the wcprb.Broadcast of a message m′, no correct process wcprb.Delivers m′ unless the process has previously delivered m.

The pseudo-code in Algorithm 4 in a few paragraphs below specifies a solution for WCPRB. This solution employs the probabilistic reliable broadcast primitive as described previously and a Valid predicate specific to some embodiments of the certificate-recording system 130.

Before introducing the Algorithm 4, the Valid predicate is first discussed. In the PRB solution, a message may be required to be properly signed to be delivered. Notice that, the processes in the certificate-recording system 130 may broadcast certificates on behalf of subnets 112. How the certificate production and submission are conducted is left to the discretion of the sending subnet 112. For this reason, the identification of the precise process that generates the certificate may not be important to the certificate-recording system 130. Instead, the certificate-recording system 130 is interested in which the subnet 112 originated the certificate. This origination information is provided inside the certificate itself by means of the subnet_id field. Moreover, each certificate is wcprb.Delivered if the casually dependent certificates have also been wcprb.Delivered.

In some embodiments, the certificate-recording system 130 may include two predicates of valid certificate and valid dependency before a valid predicate is satisfied. A message to be delivered in a certificate-recording system 130 may need to satisfy various validity conditions. Specifically, the Valid predicate (see Algorithm 3) is the conjunction of the two deterministic predicates Valid_cert and Valid_deps:
The certificate validation predicate Valid_cert (see Algorithm 1) returns true;
Any preceding certificates that a subnet Sⱼ issued have validated (implied by the linkage of certificates and encompassed in Valid_cert);
The reported dependencies of the certificate have been validated and must exist in the histories of all subnets of the dependencies, e.g., the Valid_deps predicate outputs true.

The Valid_deps predicate, as defined in Algorithm 2, returns true if for each certificate submitted by a subnet Sₖ in deps, the certificate is in historyₚ(Sₖ). Note that the predicate is monotonic because, for a certificate message m, if Valid_deps(m.deps)=true at time t then ∀t′≥t, Valid_deps(m.deps)=true. The combination of the ϵ-Consistency, the ϵ-Totality—both providing the agreement property—and weak causal order (enforced by the Valid_deps predicate) properties of the WCPRB defines extrinsic validity: The nodes of the certificate-recording system 130 are guaranteed to deliver the same weakly causally ordered sets of certificates, e.g., no subnet 112 can successfully submit conflicting certificates in order to double-spend.

Algorithm 2 Certificate dependencies validation predicate at process p

```
function Valid_deps(deps)
                ∧
      return Certᵢ ∈ deps (Certᵢ ∈ historyₚ(Sₖ = Certᵢ.subnet_id))
end function
```

When participating in the WCPRB, each process p of the certificate-recording system 130 may locally hold the following variables:
historyₚ(Sⱼ): The local set of accepted incoming and outgoing certificates involving subnet Sⱼ, for all Sⱼ (initialized and modified by Algorithm 5);
depsₚ: The local set of incoming certificates involving a subnet since the subnet's last outgoing certificate (initialized and modified by Algorithm 5);
pendingₚ: The local set of certificates pending for validation.

Note that depsₚ and historyₚ(Sⱼ) are shared between Algorithm 3 and Algorithm 5, where only the latter modifies both variables.

Algorithm 3 Certificate message validation at process p

```
function Valid(m)
  (Cert, deps) := m
  return Valid_cert(Cert) ∧ Valid-deps(deps)
end function
```

In some embodiments, the WCPRB protocol may work as follows. When process of a certificate-recording system 130 wants to wcprb.Broadcast a message m, the process verifies that Valid(m) holds before calling prb.Broadcast(m). Upon the prb.Delivery(m) event, a process p does not trigger the wcprb.Delivery of that message yet, but adds the message to the pendingₚ set. Intuitively, the state VALID is a stateful predicate. The state VALID can happen that m does not satisfy the predicate at the current time but m will satisfy the predicate after the wcprb.Delivery of other messages. Hence, new incoming messages are kept in the pendingₚ variable. As soon as there exists a message m in pendingₚ such that Valid(m) outputs true, the message m is removed from pendingₚ and delivered.

Algorithm 4 The TCE's Weak Causal Probabilistic Reliable Broadcast
at process p

```
pendingₚ := Ø
upon event wcprb. Broadcast(m) do
  if Valid(m) then
    prb.Broadcast(m)
  end if
upon event [symbol] prb.Deliver(m) [symbol]   do
  pendingₚ := pendingₚ ∪ {m}
upon exists m such that [symbol] {m} ∈ pendingₚ ∧ Valid(m) [symbol]   do
  pendingₚ := pendingₚ \ {m}
  trigger wcprb.Deliver(m)
```

### Certificate Submission and State Update

In this section, how certificates are transmitted in the certificate-recording system 130 using WCPRB is described. Algorithm 5 describes the submission of a certificate and the submission's application to the local state of certificate-recording system 130 processes.

In some embodiments, a process p of a certificate-recording system 130 may locally hold the following variables. A process p may correspond to a computing node of the certificate-recording system 130 which runs the process.
historyₚ(Sⱼ): as defined for Algorithm 3;
depsₚ: as defined for Algorithm 3;
subnetₚ: The subnet that p belongs to. If p does not belong to any subnet then subnetₚ=⊥.

To submit a certificate Cert, a subnet Sⱼ wcprb.Broadcasts an ICE-FROST signed message m=(Cert, deps). When a correct process of the certificate-recording system 130 wcprb.Delivers a certificate, the node of the certificate-recording system 130 applies the certificate to node's local state. Applying a certificate means that the node adds the certificate Cert and the certificate's dependencies deps to the history of subnet Sⱼ. More precisely, upon the wcprb.Delivery event for a message m from Sⱼ, a correct process p updates historyₚ(Sⱼ) but updates depsₚ only if the process p belongs to a subnet addressed by the cross-subnet message. Notice that, if a process p does not belong to any subnet (subnetₚ=1), then p never updates depsₚ.

The state of the certificate-recording system 130 (see Equation 2 below) is defined as the union of the history sets of the certificate-recording system 130 participants. In other words, and as shown in the equation below, the state is the set of all certificates that have been validated, wcprb.Delivered, and applied. The state of each node in the certificate-recording system 130 is local and converges with probability 1−ϵ.

$${state}_{TCE} = \{ {⋃}_{p ∈ II} ( {history}_{p} ) \} \qquad ( 2 )$$

Algorithm 5 The TCE's (certificate-recording system 130) certificate
submission and state update at process p

| | |
|---|---|
| history(Sⱼ) := Ø, ∀Sⱼ ∈ [symbol] | [symbol] [symbol] : Set of all subnets |

```
depsₚ := Ø
subnetₚ ∈ [symbol]    ∪ {⊥}
upon event submit(m) do
  wcprb.Broadcast(m)
  depsₚ := Ø
upon event [symbol] wcprb.Deliver(m) [symbol]   do
(Cert, deps) := m
historyₚ(Sⱼ) := historyₚ(Sⱼ) ∪ deps ∪ Cert
```

| | |
|---|---|
| if (subnetₚ ∈ [symbol] _{Cert}) then | [symbol] [symbol] _{Cert}: Subnets receiving messages for them in |

Cert depsₚ := depsₚ ∪ Cert
end if

Overall, the certificate-recording system 130 may add multiple key properties to the interoperability protocol of the interoperable subnet system 110:
Security: The certificate-recording system 130 enforces a weak causal ordering of certificates under asynchrony and is a more robust primitive than consensus and atomic broadcast since both of them are impossible to solve in the asynchronous model even with one crash failure.
Scalability and Decentralization: With a per-node communication and computation complexity logarithmic in the size of the system, the WCPRB protocol can sustain a very high number of participants of the certificate-recording system 130—which increases decentralization—while preserving high throughput.

In some embodiments, to prevent processes of the certificate-recording system 130 from prb.Delivering messages that will not be wcprb.Delivered, the certificate-recording system 130 may move the Valid_cert check to the reception of new messages during the PRB protocol. In other words, in some embodiments, at the reception of a message m, each correct process checks that the message m is correctly signed and that the certificate carried by the message m is well-formed (Valid_cert(Cert)=true) before processing the message m, or discards the message m otherwise. As a consequence, at the WCPRB level (see Algorithm 4), some embodiments of the certificate-recording system 130 may apply a lighter Valid′ predicate definition, as defined in Algorithm 6.

Algorithm 6 Certificate validation at process p, when Valid_cert check
is integrated into the PRB solution.

function Valid′(m)
return Valid_deps(m.deps)
end function

### Sybil Resistance

In some embodiments, the certificate-recording system 130 establishes an agreement on a set of operations among processes with equal weight. Processes are equal because the processes construct samples of peers selected uniformly at random. The certificate-recording system 130 may tolerate up to a threshold ƒ of Byzantine processes in the system. The Sybil attack, the capability of an adversary to freely create identities to overcome the ƒ threshold, can be a threat that the system needs to address. Sybil resistance is relatively easy to achieve in a permissioned system contrary to permissionless systems where membership is free. In some embodiments, the certificate-recording system 130 is a permissionless system or a system with low permission requirement. The certificate-recording system 130 may enforce that the number of Byzantine processes remain below the threshold. Notable approaches are the Proof of Work (the adversary cannot have more computational power for free) and Proof of Stake (the adversary cannot hold more assets for free). In some embodiments, the certificate-recording system 130 may implement the latter, which implies the management of an asset. In order to defend the certificate-recording system 130 against Sybil attacks, the certificate-recording system 130 leverages the staking subnet to ensure that a majority of reliable broadcast participants follows the protocol such that it is not possible to inconsistently deliver cross-subnet messages, e.g., double-spend.

Processes wishing to participate in the certificate-recording system 130 may submit a special transaction (e.g., a staking request) on the staking subnet which records the intention to join the certificate-recording system 130. This transaction includes a fixed amount, denominated in TOPOS, as well as an identifier of the participant and it locks the TOPOS amount on the staking subnet. Non-free registration of participants provides the basis for a Sybil resistance mechanism in the certificate-recording system 130. Participants communicate only with peers registered on the staking subnet.

### Cross-Subnet Operation Protocol

Conventionally, interoperability protocols have fallen into disjointed categories depending on their design goals. Trusted interoperability protocols have relied on external verifiers—administrators of centralized protocols or incentivized relayers in decentralized protocols—to bridge the interoperated chains, allowing for cross-chain message passing at the cost of trust in verifying entities that are external to the blockchains implementing the protocol (depending on an auxiliary, often much weaker, cryptoeconomic security). On the other hand, trustless protocols have found solutions to remove the need for trust in third parties: Some protocols have centered their design on the multiplication of non-colluding verifying networks, while others have removed the need for external verification by solely depending on the chain's own actors to natively verify data cross the chains. These models impose trust in the consensus security of the interoperated chains and as such do not permit true trustlessness.

The interoperable subnet system 110 provides a solution that cryptographically enforces validity of cross-subnet messages without the need for trust in any external verifiers nor consensus security. The interoperable subnet system 110 allows subnets 112 to exchange messages with each other trustlessly and safely. The interoperable subnet system 110 provides uniform security in the cross-chain interoperability landscape and allows secure communication between decoupled blockchains.

In some embodiments, the cross-subnet operation protocol of the interoperable subnet system 110 may be built on three major pillars enabled by the components discussed in the certificate, signature, and message protocols discussed in the previous sections.
The reliable broadcast protocol of the certificate-recording system 130 allows for consistent delivery of causally ordered subnet certificates.
Certificates include a zkSTARK validity proof of the committed state transition; thus, the nodes in the certificate-recording system 130 can attest to the validity of cross-subnet messages without the need to trust the sending subnet 112.
Certificates are authenticated by means of an ICE-FROST signature; receiving subnets can thereby be ensured that delivered certificates were not tampered with.

A cross-subnet message represents a request initiated by a user from a subnet 112 to execute a transaction in a remote subnet 112. It may take the form of a function call of a dedicated protocol-level autonomous program protocol 162 (e.g., a smart contract of the sending subnet 112). This dedicated protocol-level autonomous program protocol may be referred to as a TOPOS Core contract, although the name can be arbitrary. The TOPOS Core contract may be executed on the sending subnet 112 and is to be interpreted on the receiving subnet 112 as another function to call. The TOPOS Core contract function to call on the sending subnet 112 depends on the type of message requested.

For example, in an asset transfer, an asset is burnt/locked on the sending subnet 112 and equivalently minted on the receiving one 112. A portion of the function call message may include the following:

```
transferAsset (
  subnet_id: Identifier of the receiving subnet,
  asset_id: Identifier of the transferred asset,
  recipient_addr: Recipient's address on the receiving subnet,
  amount: Amount to be transferred
)
```

In another example, for an arbitrary function call, an autonomous program protocol 162 on the receiving subnet 112 is called from the sending subnet 112. A portion of the function call message may include the following:

```
callArbitraryContract (
  subnet_id: Identifier of the receiving subnet,
  contract_addr: Address of the autonomous program protocol 162,
  func_name: Name of the function to call,
  func_args: Arguments to pass to the function call
)
```

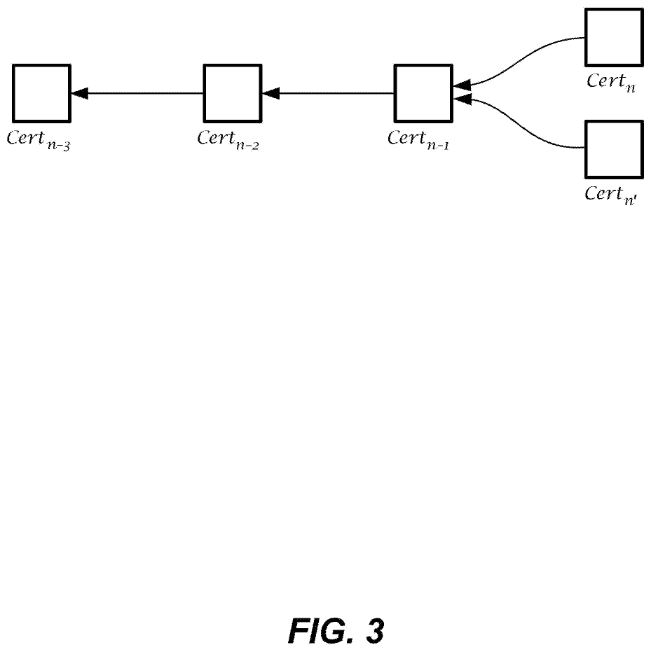

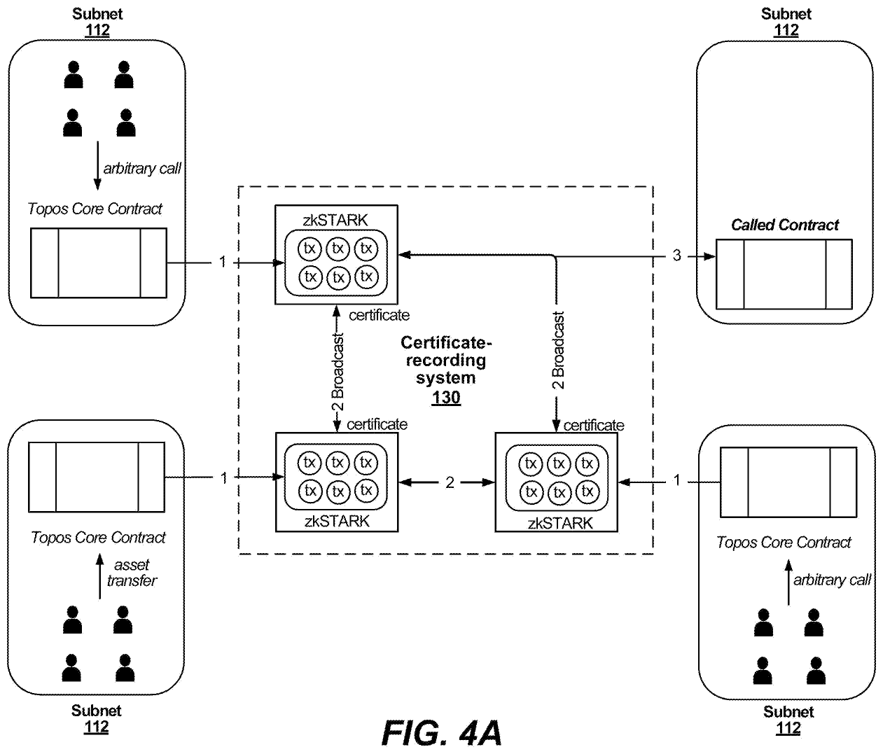

FIG. 4A is a conceptual diagram illustrating one or more cross-subnet operations, in accordance with some embodiments. The contracts in various subnets 112 may be examples of autonomous program protocols 162. In some embodiments, one or more subnets 112 may not be a blockchain and the contract may be replaced as a program protocol. The protocols in the interoperable subnet system 110 enable interoperability of subnets 112 via the transmission flow of cross-subnet messages illustrated in FIG. 4A. Once a new cross-subnet message emitted by a user is part of the canonical chain of the subnet 112, the cross-subnet message becomes ready for certification as per the rules of the certificate interface 120. For example, the cross-subnet message may be batched with an arbitrary amount of operations (e.g., operations within the subnet 112 and other cross-subnet operations) to form a new state transition whose validity is to be proven in a new authenticated certificate. Once created, the message is delivered throughout the network of the certificate-recording system 130 via the reliable broadcast primitive and eventually collected by the receiving subnet 112. Thanks to the validity and authentication properties protected by the certificate interface 120 and the consistent delivery protected by the certificate-recording system 130, the receiving subnet 112 can trustlessly and securely interpret the cross-subnet message and execute the request transaction locally.

In order to verify the zkSTARK proof included in a certificate, the nodes in the certificate-recording system 130 do not need access to the subnet state. The zkSTARK verifier only accesses the hash of the state committed to in the previous certificate of the same subnet 112, and the hash of the new state committed to in the new certificate. This means that even though the size of the subnets' state transitions can be extremely large, the verification is nearly-optimal and the storage requirement for the nodes of the certificate-recording system 130 is kept very low. Keeping the state of the certificate-recording system 130 small allows new joining nodes to synchronize quickly and keep the burden of storing the certificates low, even when the interoperable subnet system 110 processes a large amount of cross-subnet messages. While the size of the state of the certificate-recording system 130 grows linearly with the number of certificates, the overhead of storing new certificates remains acceptable.

Since the cost of storing the state of the certificate-recording system 130 is kept low, it is possible for actors with low-cost hardware to participate in the certificate-recording system 130, thus increasing the decentralization of the certificate-recording system 130.

### Example Cross-Subnet Operation Message Flow

FIGS. 4B and 4C are sequence diagrams illustrating an example series 400 of a cross-subnet operation carried out among components of the interoperable subnet system 110, in accordance with some embodiments. The series 400 illustrated in FIGS. 4B and 4C represents specific sets of instructions that may be stored in one or more computer-readable media, such as memory of different servers. The instructions, when executed by one or more processors of the depicted entities, cause one or more processors to perform the described interactions. As depicted in FIGS. 4B and 4C, the series 400 is performed by the sender user computing device 402, a sending subnet 404, the certificate-recording system 130, a recipient subnet 406, and a receiver user computing device 408. The sender user computing device 402 and recipient user computing device 408 are examples of the computing devices 180. While the terms sender and recipient are used and the cross-subnet operation is primarily discussed using a cross-subnet asset transaction as an example, the cross-subnet operation may not involve any asset transaction. The sender and recipient may also be referred to as an initiator and a receiver or simply the first user and the second user. Likewise, the terms sending and receiving in the sending subnet 404 and the recipient subnet 406 do not imply that the cross-subnet operation involves an asset transfer. The sending subnet 404 and recipient subnet 406 are examples of subnets 112. Also, the steps in the series 400 are examples only and the order of those steps may also be changed in various embodiments. Also, each of the sending subnet 404, the recipient subnet 406, and the certificate-recording system 130 may take the form of distributed systems. Hence, while one or more steps are described to be performed by a distributed system, in some embodiments it might be one of the computing nodes of the system that performs the step.

In some embodiments, the sender user computing device 402 may initiate an operation request and transmit 410 the operation request to the sending subnet 404. The operation may be a cross-subnet operation. The operation can be of any suitable nature, such as the transfer or exchange of assets (e.g., an asset that is native to the sending subnet 404 and a wrapped representation on the recipient subnet 406 or a wrapped representation on the sending subnet 404 and an asset that is native to the recipient subnet 406), a request to execute a function call (e.g., an autonomous program protocol 162) residing in the recipient subnet 406, sending a cross-subnet message content, perform a multi-party computation that involves the two subnets, and another suitable operation. For the purpose of illustration, a cross-subnet asset transaction is used as a primary example in the series 400.

Upon receiving the operation request, the sending subnet 404 may verify 412 the operation prerequisites. For example, the prerequisites may include any authentication requirements, authorization requirements (e.g., whether the user of the sender user computing device 402 is authorized to perform the operation under one or more policies of the organization 170 operating the sending subnet 404 or the policies of the sending subnet 404), and operation requirements (e.g., whether the account associated with an asset transfer has sufficient balance, etc.). Upon verifying that the sender user computing device 402 can complete the operation, the sending subnet 404 may execute 414 a portion of the cross-subnet operation. The portion may be any operations steps that require the sending subnet 404 to complete, such as putting the amount of asset in transfer on hold, getting ready for the asset to be burnt upon completion of the cross-subnet operation, or any operational steps for operations that are not related to asset transfer. The sending subnet 404 may generate 416 a proof of computational integrity. The proof of computational integrity may be a zero-knowledge proof such as various examples of proofs that are discussed in this disclosure, including zkSTARK. The proof of computational integrity may include proof that the operation prerequisites have been verified and that the portion of the cross-subnet operation has been executed. The sending subnet 404 may also generate 420 a certificate, such as based on the protocols used in the certificate interface 120, which may include the use of ICE-FROST signature.

The sending subnet 404 may in turn broadcast 422 the certificate to the certificate-recording system 130. The certificate may include proofs that the cross-subnet operation is ready to be executed by the recipient subnet 406. The sending subnet 404 may transmit 424 the cross-subnet operation request to the recipient subnet 406. The cross-subnet operation request may take the form of a cross-subnet operation message that may include the certificate and a request for the recipient subnet 406 to complete the operation. Alternatively or additionally, the cross-subnet operation request may also be broadcasted to the certificate-recording system 130.

After the certificate-recording system 130 receives the certificated broadcasted by the sending subnet 404, the certificate-recording system 130 may carry out a verification process to verify 426 the certificate. The verification process may include the certificate submission and subnet state update detail discussed above, such as including the weak causal probabilistic reliable broadcast discussed.

The recipient subnet 406, upon receiving a cross-subnet operation request, may retrieve 430 relevant certificates from the certificate-recording system 130. The recipient subnet 406 may verify a given certificate has been processed by the certificate-recording system 130 to execute the operation request. The certificate-recording system 130, based on the casual relationships of the certificates, may transmit 432 the relevant certificates to the recipient subnet 406. The recipient subnet 406 may verify 434 the certificates. At least one of the certificates is transmitted from the sending subnet 404 and serves as part of the proof that the operations of the sending subnet 404 are valid.

Referring to FIG. 4C, upon verifying the relevant certificate(s), the recipient subnet 406 may execute 440 the portion of the cross-subnet operation. For example, if the operation is a cross-subnet asset transaction, the recipient subnet 406 may mark that a certain quantity of an asset residing on the recipient subnet 406 is ready to be assigned to the receiver user computing device 408, such as ready to be sent to the blockchain address associated with the receiver user computing device 408 on the recipient subnet 406. The recipient subnet 406 may also generate 442 a proof of computational integrity that the portion of the cross-subnet operation carried by the recipient subnet 406 is valid. The recipient subnet 406 may also generate 444 a certificate and broadcast 446 the certificate to the certificate-recording system 130. Again, the certificate-recording system 130 may verify 450 the certificate to confirm that the certificate is valid with respect to the history of the recipient subnet 406.

The recipient subnet 406 may transmit 452 a cross-subnet operation message to the sending subnet 404 to signify that the recipient subnet 406 has executed a portion of the cross-subnet operation. Alternatively or additionally, the cross-subnet operation message may be broadcasted to the certificate-recording system 130. The sending subnet 404, in turn, may retrieve 454 the certificate generated in step 444 and confirms that the certificate-recording system 130 has processed the certificate. The certificate-recording system 130 may transmit 456 the relevant certificate to the sending subnet 404. The sending subnet 404 may in turn verify 466 the certificate.

Upon successful verification, the sending subnet 404 may complete the operation and mark 470 the cross-subnet operation as completed. The sending subnet 404 may generate 472 another proof of computational integrity that indicates that the cross-subnet operation has been completed. The sending subnet 404 may generate 474 another certificate and broadcast 476 the certificate to the certificate-recording system 130.

After everything is verified, the sending subnet 404 may complete 480 the operation with the sender user computing device 402. Likewise, the recipient subnet 406 may complete 482 the operation with the receiver user computing device 408.

### Composability of an Interoperable Subnet System

Composability is a design principle that is found when various applications (e.g., program protocols residing in different subnets 112) can compose their value by invoking each other's functions. In the interoperable subnet system 110, composability is enhanced in at least two different manners, which may be referred to atomic composability and asynchronous composability.

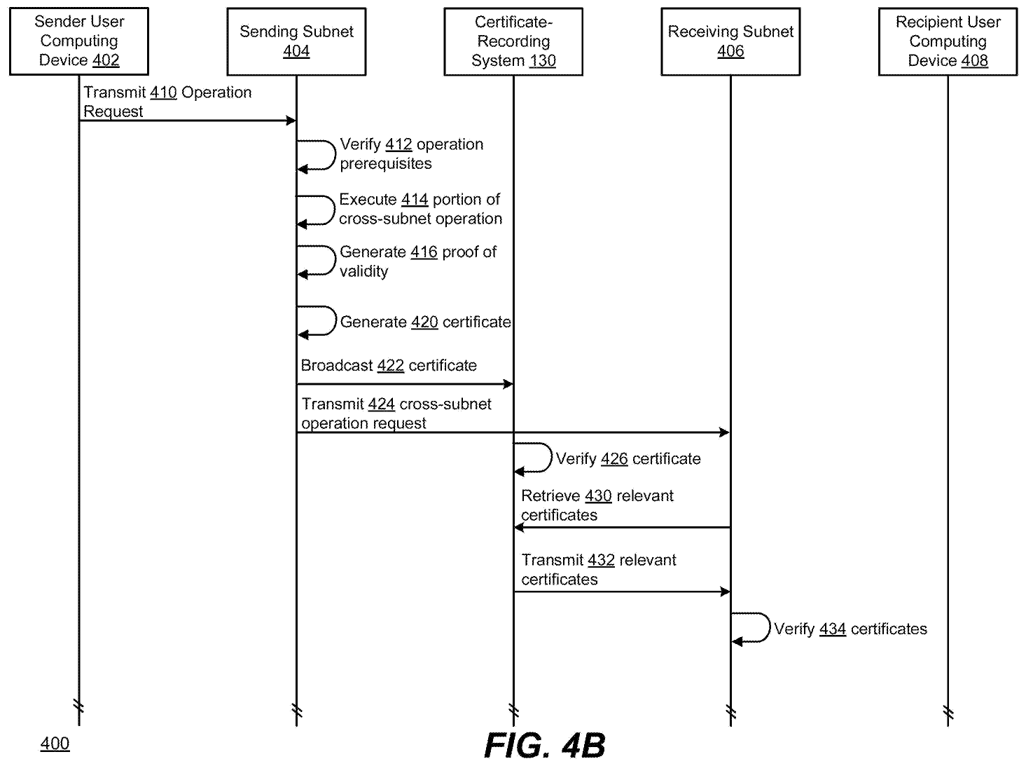

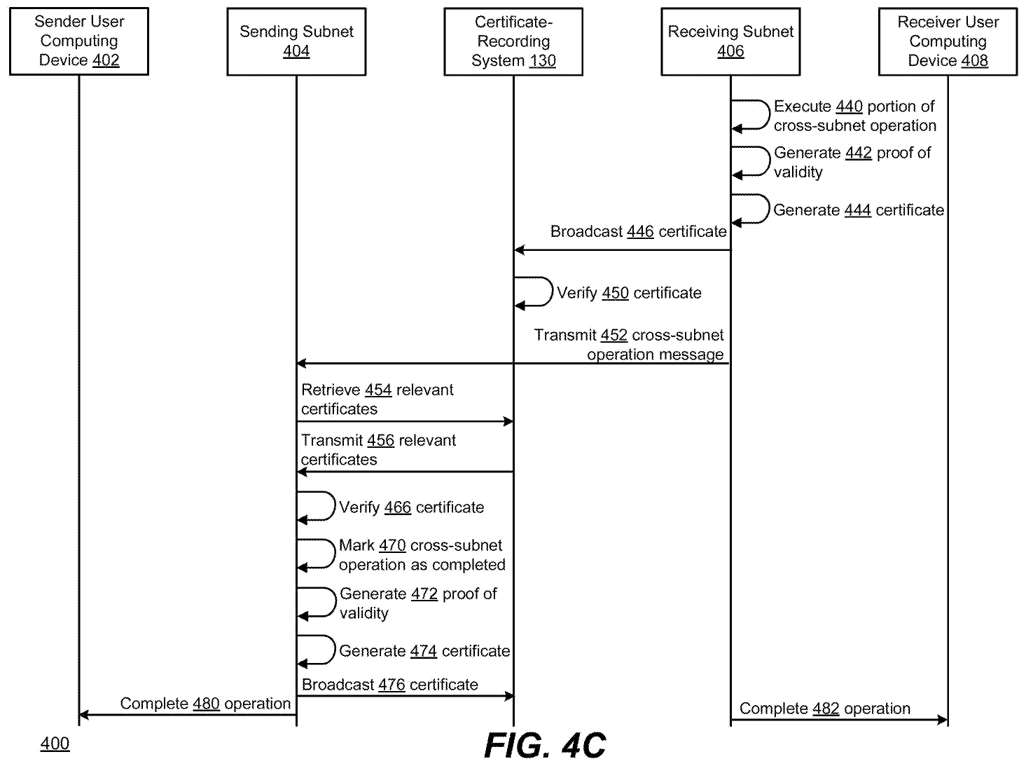

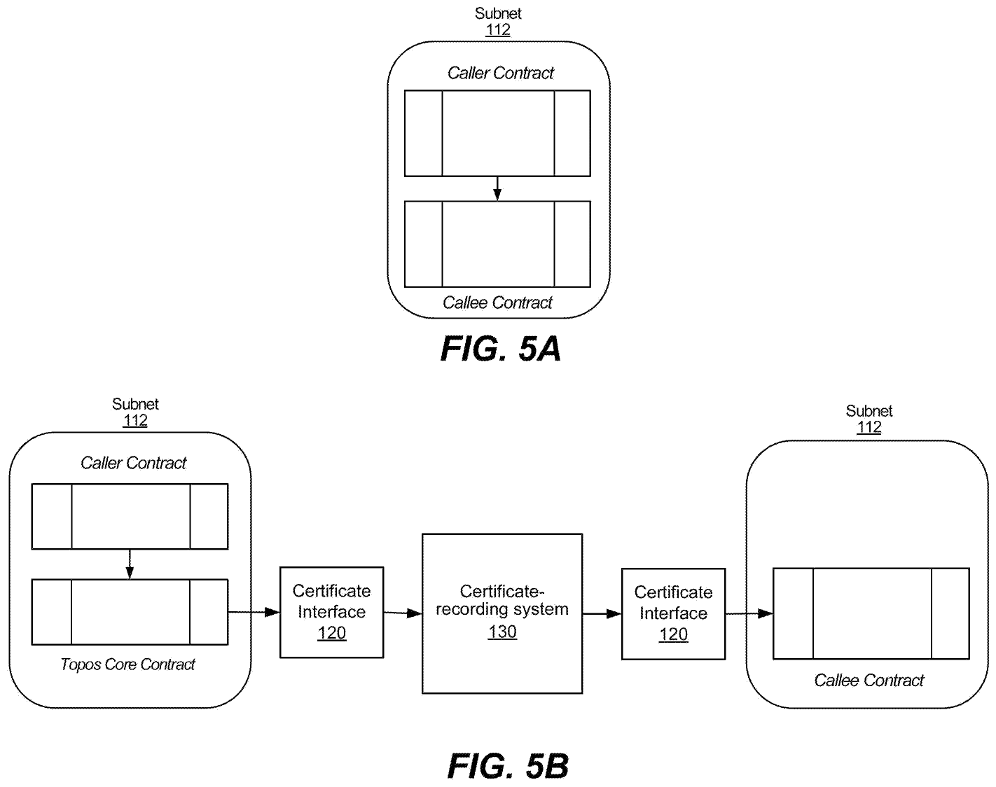

For atomic composability, within a single subnet 112, developers can deploy autonomous program protocol 162 that invoke other autonomous program protocols 162 synchronously, e.g., execute contract-to-contract calls that are executed one after the other and only if the previous operation was successfully completed. If a single operation fails, the whole transaction is reverted. In this context, composability is described as atomic for either all operations or none are executed. Conventionally some database applications require atomic operations. The features of the 110 allows atomic composability, which enables subnets 112 to safely transition their states and prevents the subnets 112 from facing corrupted state introduced by composed contract calls that fail in the middle their execution. The interoperable subnet system 110 may implement atomic composability. FIG. 5A is a conceptual diagram illustrating an atomic composability feature of the interoperable subnet system 110 within a subnet 112, in accordance with some embodiments.

For asynchronous composability, in addition to atomic intra-subnet composability, the interoperable subnet system 110 permits inter-subnet asynchronous composability, e.g., the capability of different applications deployed on multiple subnets to invoke each other. FIG. 5B is a conceptual diagram illustrating an asynchronous composability feature of the interoperable subnet system 110, in accordance with some embodiments. Users of a sending subnet 112 can emit cross-subnet asset transfers or remotely invoke arbitrary autonomous program protocol 162 from different subnets 112 by calling functions of the Topos Core contract. To obtain composability across subnets 112, developers can atomically compose their autonomous program protocols 162 with the Topos Core contract, e.g., programmatically execute cross-subnet operations or remote contract calls as part of their own functions of the autonomous program protocols 162. Subnets 112 can include calls to these composed autonomous program protocol 162 in certificates for receiving subnets 112 to learn about these new types of cross-subnet messages (see FIG. 5B).

Asynchronous composability is enabled in the interoperable subnet system 110 by the certificate interface 120 and the certificate-recording system 130, and is provided to any applications deployed on any subnets.

### Incentive System Design

In some embodiments, the interoperable subnet system 110 and/or the certificate-recording system 130 may include incentives for the various actors of the ecosystem by means of a native token, TOPOS, associated with a staking subnet.

In blockchain systems, actors may deviate from the blockchain protocol, when such deviation will lead to more individual gain. As an example, they deviate to earn more rewards than when following the prescribed protocol. These actors may be referred to as rationals. The interoperable subnet system 110 aims at being tolerant to Byzantine faults when the participants are rational.

The interoperable subnet system 110 may implement features to prevent the verifier's dilemma in which correct processes choose not to verify certificates because the verification is more computationally expensive than verifying operations, or doing anything at all. Even if requiring the reliable broadcast participant to stake an amount of TOPOS is sufficient to provide guarantees against Sybil attacks, it is not sufficient on its own to incentivize participants of the certificate-recording system 130 to follow the prescribed protocol. In fact, the system can still be subject to many predicaments, such as the verifier's dilemma. Thus, in some embodiments, to ensure proper verification and execution of certificates, participants of the certificate-recording system 130 who correctly followed the protocol may be rewarded accordingly. Such rewards come from applying a special fee to cross-subnet messages. Fees associated to cross-subnet messages are denominated in TOPOS and are collected by participants of the certificate-recording system 130 with respect to the participants' work.

Without such incentives, undesired situations can happen. For example, no one verifies certificates and as such invalid certificates can be spread in the system, or certificates could stay in pending for a long amount of time, increasing the end-to-end cross-subnet communication latency. The incentive model may guarantee that all certificates are processed since those certificates may potentially contain a large number of cross-subnet messages. To ensure the performance of the system, a desirable objective of the incentive model is to process the certificates as quickly as possible. Verifying and executing certificates should be an interesting and lucrative activity incentivizing rational participants of the certificate-recording system 130 to behave well, e.g., the incentive model should not reward participants who do not contribute to the system.

The incentive may be implemented by a proof-of-activity mechanism. Since the communication in the certificate-recording system 130 is not synchronous, assessing whether a node does not participate is generally impossible for one cannot distinguish if a node is slow or if it is not working. The alternative approach is to prove that a node was active. Notice that this approach cannot, however, account for slow nodes. A proof-of-activity for a node or a set of nodes proves that their work has been seen and was considered by sufficiently many participants of the certificate-recording system 130. Since messages are signed, the proof-of-activity can consist of the set of messages delivered by a node. However, exchanging such sets of messages will induce a high communication overhead and will require too much storage on the subnet 112. In some embodiments, the proof-of-activity may rely on aggregation techniques.

In some embodiments, the interoperable subnet system 110 or the certificate-recording system 130 may also implement cross-subnet fees. Cross-subnet fees may be required to be paid in order for the requested operation to be executed on the receiving subnet 112 by the subnet's validators. To estimate these fees, the operation originator (a participant of the sending subnet 112) can ask a service to estimate the fee required to execute the given operation. The service estimates and returns the result based on the fee calculation of the receiving subnet 112. One possibility is for this service to be exposed by a system of decentralized oracles like CHAINLINK. Internally, the estimation provider may estimate the resources consumed by processing the operation requested in the cross-subnet message based on the current receiving subnet state.

### Uniform Security

The interoperability protocol allows for trustless interoperability. A sending subnet 112 is responsible for proving that operations are valid executions of the zkVM, signing certificates that include cross-subnet messages, and sending the certificates to the certificate-recording system 130 for broadcast in the ecosystem, while a receiving subnet 112 is responsible for correctly applying the cross-subnet messages, e.g., submitting the requested transactions in their network.

The interoperable subnet system 110 may include a uniform security is realized by the combined properties of the certificate interface 120 and the certificate-recording system 130. For example, the uniform security may include intrinsic validity of certificates, ensured by the Valid_cert predicate of the certificate interface 120. The uniform security may also include extrinsic validity of certificate messages, ensured by the WCPRB's agreement property and Valid_deps predicate implemented by the certificate-recording system 130.

With respect to intrinsic validity, in some embodiments, the computational integrity of subnets' state transitions may be fully decoupled from the consensus security of the related subnets and may be entirely ensured by zkSTARK proofs. This may make an adversary computationally infeasible to forge a proof of computational integrity, e.g., convince a verifier that an invalid transaction was correctly executed by the zkVM. In this setup, receiving subnets 112 benefit from an unparalleled level of security for they are assured that certified state transitions are valid. Put another way, if the certificate interface 120 certificate validation predicate Valid_cert outputs true, cross-subnet messages are guaranteed to be intrinsically valid.

With respect to extrinsic validity, in some embodiments, the certificate messages that are delivered by nodes of the certificate-recording system 130 are guaranteed not to be conflicting with each other while the certificates form weakly causally ordered sets which capture the weak causal precedence between messages. This is achieved if the Valid_deps predicate of the certificate-recording system 130 outputs true, which triggers the wcprb.Delivery when intrinsic validity is also verified. This may make malicious subnets infeasible to successfully double-spend and deceive honest receiving subnets into executing conflicting cross-subnet messages.

In some embodiments, as soon as a certificate is delivered, intrinsic validity and extrinsic validity may be enforced. This provides the ecosystem with uniform security. The safety of executing cross-subnet messages internally on receiving subnets 112 is independent of the security of sending subnets 112. The trust in cryptographic primitives in lieu of bridge verifiers and/or blockchain consensus as to proving the validity of the message is a fundamental innovation in the field of blockchain interoperability. It is infeasible to create a certificate containing an invalid state transition and to create conflicting certificates in order to double-spend across the ecosystem, even in the presence of a malicious subnet, e.g., more than ⅔ of its validators are controlled by an adversary.

In the practical case of a cross-subnet asset transfer, a sending subnet 112 submits a certificate containing a proof of the validity of the asset transfer transaction. This transaction, after checking that the balance of the sender was sufficient to allow the transfer, proceeded with locking/burning the assets to be transferred. Once delivered and verified, the certificate gives total insurance to the receiving subnet 112 that the balance check and the lock/burn operations were conducted with success on the sending subnet 112. This demonstrates that no malicious entity can simulate that some assets were locked/burnt in the context of a cross-subnet asset transfer, preventing them from arbitrarily minting tokens on the receiving subnet 112.

Additionally, the feature of uniform security allows for the interoperable subnet system 110 to implement a trustless burn-mint asset transfer model. Receiving subnets 112 do not need to trust sending subnets 112 to have correctly burnt assets before minting. More secure than the lock-mint model, burning assets on sending subnets 112 ensures that no authority can steal user assets sent across multiple chains. By enabling a trustless burn-mint asset transfer model, the interoperable subnet system 110 paves the way for a new kind of asset bridge paradigm where tokens can be natively and frictionlessly deployed and managed on any blockchains.

With certificates being stored on the certificate-recording system 130, the submitted commitments to the state of subnets may be immutable and hence that subnets' states cannot be reverted to states prior to the ones committed to in the latest delivered certificates without creating conflicts. In the event that a subnet reorgs to such state, the certificate-recording system 130 would prevent the delivery of new certificates committing to a new state as these certificates would conflict with the latest delivered certificate. This may be guaranteed by the monotonicity of the certificate-recording system 130 message predicate: If for any message m, Valid(m) is true at time t then it remains true at any time t′≥t. Once a certificate message is delivered via the WCPRB primitive, the certificate is considered to be final.

### Example Application: Subnets as Layer-2 to Interoperate Layer-1

The interoperable subnet system 110 can suit various different use cases. Below are outlined three use cases which hint at the vast capabilities that the interoperable subnet system 110 is capable of.

Subnets 112 may be general-purpose blockchains. In some embodiments, subnets 112 can host any type of application and prove the subnets' state transitions using the zkVM, a virtual machine that allows for the execution of arbitrary provable computation. One example use case of the interoperable subnet system 110 is that blockchain layer-2 (L2) protocols may scale layer-1 (L1) blockchain networks by delegating the execution of transactions to an offchain network and by relying on validity proofs to update the L2 state view on the L1, e.g., zk-rollups. L2 protocols separate the execution and settlement layers. Traditionally, the two layers are combined: Transactions (execution layer) are executed locally by a participating node when importing a block that has been validated by the network consensus rules (settlement layer).

FIG. 5C is a conceptual diagram illustrating the concept of layered scalability, in accordance with some embodiments. In layered scalability, participating subnets are execution layers which delegate state settlement to external L1 networks. One may notice that L1 networks can greatly benefit from the instantiation of new zk-rollup subnets for they can delegate part of their execution layer and hence better scale by settling many more transactions per second. Subnets are L2 zk-rollups scaling existing secure L1s (e.g., Ethereum, Avalanche). In this configuration, settlement happens on the L1 networks where subnets publish their proofs of valid state transition.

The interoperable subnet system 110 may indirectly enable interoperability between decoupled L1 blockchains: Any L1 chain that hosts bridge smart contracts bridging assets with a subnet 112 is de facto compatible with all other subnets 112 in the interoperable subnet system 110, some of which are to be zk-rollups of other L1 networks and as such are capable to route cross-subnet messages back to their assigned L1 chain.

By design, L2 networks offer much cheaper transaction fees than L1 blockchains for they are parallel networks that do not face similar levels of congestion (if they were, the protocol operators could simply spawn a new instance of the protocol and delegate part of their execution workload to it). For that reason, dApps have been making the move to L2 and so have been their L1 users. By moving to the interoperable subnet system 110, L1 users might enjoy lower fees and additionally gain for free interoperability with all other subnets in the ecosystem and in fine with all the other bridged L1 networks. The interoperable subnet system 110 offers interoperability with scalability for free for existing L1s.

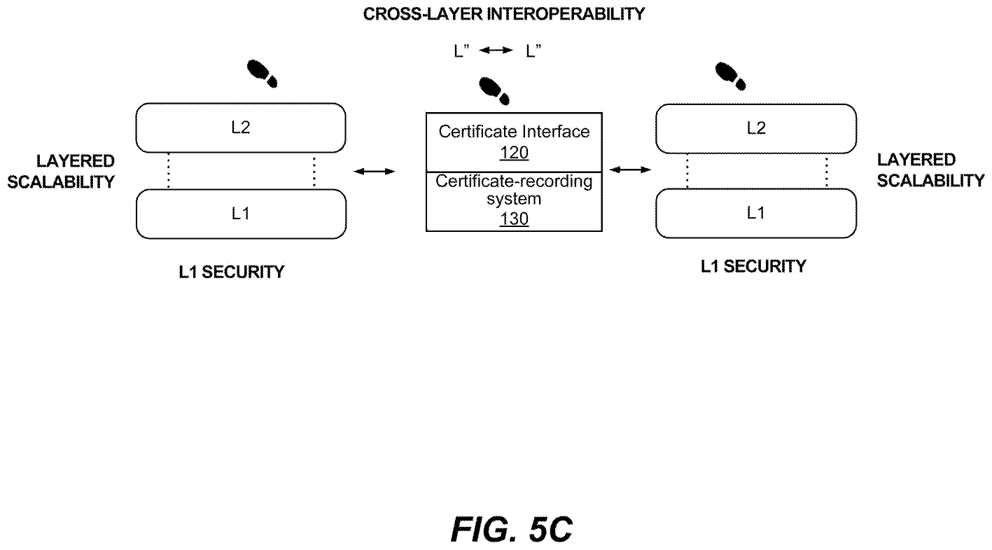

FIG. 6 is a block diagram that conceptually illustrates a data flow in inter-layer operability, in accordance with some embodiments.

First, to send funds to an L2 subnet, users deposit assets into a bridge contract on the underlying L1 blockchain. An equivalent number of wrapped assets is then minted on the L2 subnet for the user once the lock transaction is processed (classic lock-mint model found in most bridge protocols).

Second, the users can initiate (wrapped) asset transfers to any other subnet in the ecosystem. They can also use their wrapped assets to pay fees when submitting requests for general-purpose computation execution, either locally on their subnet, or remotely on any other subnet (remote arbitrary transaction).

Third, a large number of subnet transactions are batched and proven by a zkSTARK proof which is transmitted to the L1 blockchain for L2 state settlement and to the rest of the interoperable subnet system 110 via certificates.

Fourth, the certificate-recording system 130 reliably broadcasts certificates throughout the ecosystem. Once certificates are delivered to all nodes of the certificate-recording system 130, the validators of receiving subnets can process the included requests for remote transaction execution and submit requested transactions locally in their subnet network.

### Example Application: Decentralized Finance (DEFI)

DeFi is one of the predominant use cases of web3 technologies today, with global TVL (Total Value Locked) reaching amounts in the hundreds of billions of USD. The problem is that the locked value remains isolated in silos, inaccessible for user-friendly and secure exchange options are still lacking. In most cases, liquidity, staking, loans, and other forms of DeFi value remain locked off in individual protocols, e.g., smart contracts, on individual blockchains. Due to this condition, crypto assets often lay idle in users' wallets as there is limited scope for their use within individual blockchains. And in turn, DeFi is unable to realize its full potential.

To unlock the true potential of decentralized finance and capture massive value it is essential to allow for seamless composability of platforms and applications across different blockchain ecosystems, so that assets can move frictionlessly across different blockchain networks and be used in any DeFi protocols on any blockchains. Using trustless bridges is the best fit for DeFi because they are non-custodial, and from a security viewpoint they only leverage the security of the interoperated blockchains. Because of Topos' innovations, which give superior security guarantees than other so-called trustless interoperability protocols, value can move freely and securely from one DeFi protocol to another. The properties provided by Topos greatly enhance DeFi's potential to establish itself as a ubiquitous substitution for traditional financial systems.

### Example Application: Enterprise Adoption

The two major problems preventing enterprise adoption of blockchain technologies are the lack of interoperability and the lack of privacy.

With respect to the lack of interoperability, Companies and organizations build value by assembling proprietary data and by controlling which part of it they expose in their products and services. Enterprises often prosper by composing value with other companies and to that end have traditionally, in the Web1-2 era, used ubiquitous infrastructure and technologies such as authenticated RESTful APIs to interface their products and services with their partners' without friction nor extra cost. Unfortunately, Web3 technologies have yet to create such standards. For enterprises to use Web3 and blockchain technologies, there is a need for a frictionless interoperability model in which blockchains running proprietary business logic and storing proprietary data can exchange and capture value openly and without the requirement to expose their private and hidden information.

Privacy is another challenge of blockchain technologies. One of the greatest strengths of the technology is the transparency that comes from having a distributed record of transaction history that is public and easy to verify. Yet, it poses a threat to the privacy of organizations and users. Enterprises which want to protect their trade secrets and other sensitive information are therefore reluctant to embrace even the most prominent permissionless blockchain protocols and hence have favored the private/permissioned blockchain architecture.

The interoperable subnet system 110 allows an unbounded heterogeneous set of public and private blockchains to interoperate with each other while preserving the privacy of their internal state. As such, the interoperable subnet system 110 solves for both blockchain interoperability and privacy, and hence is the springboard for adoption of the technology by enterprises.

### Additional Proof and Cryptographic Detail

The following includes additional detail on assumptions, cryptographic proof, and other example algorithmic detail. While specific examples and detail are discussed, the disclosure and various embodiments of the interoperable subnet system 110 are not limited to the following detail discussed below. Even though in some statements below terms such as “required” are used, those of ordinary skill in the art would understand that the conditions and features discussed are not limiting and can be optional.

STARK Proof System

Assumptions: the only assumption required by STARK proof systems is that the hash functions to be used for commitments are collision-resistant. This allows for simpler, leaner, post-quantum and trustless proving systems than other SNARK systems.

Prover: The STARK proof construction can be decomposed into four stages.

Algebraic Intermediate Representation (AIR). First there is need for an algebraic representation of the problem. Consider the set [symbol] of the multivariate polynomials Pᵢ in variables X and Y, [symbol] ={P₁(X, Y), . . . , Pₛ(X, Y)}, where X=(x₁, . . . xₖ) and Y=(y₁, . . . yₖ) represent the states of the current and next computation respectively. That is, for two correct vectors X, Y, we have that X, Y is a correct solution for the system [symbol] , e.g. P₁(X, Y)= . . . =Pₛ(X, Y)=0. For efficiency of both prover and verifier, we need minimal AIR, which is minimizing:
1. deg( [symbol] )=max (deg(P₁), . . . , deg(Pₛ));
2. k, the state-width;
3. | [symbol] |=s;
4. c, the machine cycle count (that may depend in general on arbitrary input, but is here linear in the size of the input set).

To be able to extend and commit to the trace efficiently, the number of steps is increased so that the number of rows reaches the next power of 2, T, for efficient FFTs.

Execution trace for a program can be seen as a T×k matrix in which:
each row is describing the state of the computation at a given step;
each column tracks a the content of a register over time.

Extension of the trace and commitment. We can view any column of the execution trace as a polynomial over a certain domain (generated by g∈ [symbol] ). We can then consider the same polynomial over the domain S= [symbol] ω [symbol] , where ω is a root of g. This is referred to as the Low Degree Extension. The evaluation of a column polynomial ƒ on S makes a code word of a Reed-Solomon code of some rate ρ (ρ=1/β with β the ratio between the original trace domain and the augmented LDE domain). That is, ƒ∈RS[ [symbol] , S, ρ]. To prevent forging of proofs, it is important that the prover cannot change these values later on. Rather than sending all of these points (since we want succinctness and zero knowledge), the prover creates a commitment to the values with a Merkle tree structure (the leaves being a grouping of evaluations of all the polynomials at a given LDE point). The commitment, along with the public inputs as part of the AIR program, is used to seed a public coin to allow drawing of random values to make the protocol non-interactive with the Fiat-Shamir heuristic.

If RAPs (see below) are being used, auxiliary trace segments can be computed after the previous trace portion has been committed to.

Constraint composition polynomial and consistency proof. Similarly, the constraint polynomials Pᵢ may be composed with the column polynomials (ƒᵢ for i=1, . . . , n) and evaluated at the points of the LDE. However, instead of creating separate evaluations for each constraint, random coins are drawn and used to create a random linear combination of the constraint polynomials. In this combination, the degrees of all constraint polynomials are augmented to all be D (the next power of 2 following the maximum degree). Due to its higher degree, more coefficients are needed to specify it. These are arranged in several columns (H₁, . . . , H_{D}), which are committed to analogously to the trace polynomials. This commitment is once again used to seed the randomness, and from this a random out-of-domain point z is sampled. The prover then provides the values necessary to evaluate the constraint composition polynomial in two ways: directly through the column values Hᵢ committed to, and indirectly by evaluating the constraint polynomials at the corresponding points of the trace polynomials and performing the same linear combination as before. These values are added to the proof and the randomization of the public coin.

Fast RS Interactive Oracle Proof of Proximity (FRI). The underlying idea of FRI, is to apply a similar degree-reduction to what's happening during the Inverse Fast Fourier Transform (splitting a polynomial in two instances over even and odd powers of a variable), and bind prover's responses in these reductions by evaluations of the function f over points of the subset S. More formally, if we can represent S as [symbol] ω [symbol] (s.t. ω generates a multiplicative group of order 2^{k}) and the function ƒ⁽⁰⁾: S→ [symbol] to be the function known by the prover of degree d≤ρ|S|. The verifier will sample a random x⁽⁰⁾, and ask the prover to compute ƒ⁽¹⁾=ƒ₀+x⁽⁰⁾ƒ₁, where ƒ⁽¹⁾ will have degree

$$\leq \frac{ρ \vert S \vert}{2} = \frac{ρ \vert 〈 {ω}^{2} 〉 \vert}{2}$$

for any x chosen by the verifier. Here, ƒ₀, ƒ₁ are two polynomial functions such that ƒ⁽⁰⁾(x)=ƒ₀(x²)+xƒ₁(x²). That is, they are functions [symbol] ω² [symbol] → [symbol] with interpolants P_{ƒ}_{₀}, P_{ƒ}_{₁} which are used to compute the original interpolant of ƒ⁽⁰⁾. If ƒ⁽⁰⁾ is δ-far from RS[ [symbol] , S, ρ], then the resulting ƒ⁽¹⁾ will be δ′-far for some δ′≤δ. This process is repeated for a number of layers until the polynomial ƒ^{(l)} is reached which should be constant (or of low enough degree that it can be checked directly in constant time).

If the original ƒ⁽⁰⁾ was far from any polynomial in RS[ [symbol] , S, ρ], then (with high probability) f^{(l)} is not constant. This property of FRI is used to succinctly prove that a certain polynomial is of low degree. That polynomial is known as the DEEP composition polynomial (from Domain Extension for Eliminating Pretenders). It is a polynomial constructed to be of low degree only if the values previously supplied by the prover (for evaluation of the constraint composition polynomial) are consistent with the polynomials previously committed to. Due to its structure, low-degreeness of the DEEP composition polynomial also implies that the trace polynomials and column polynomials for the constraint composition are of suitably low degree.

Verifier: To verify a proof given by a prover, the verifier must perform the following steps.
1. Read the commitment to the execution trace over the LDE domain, updating the public coin and drawing from it random coefficients used by the prover to compute the composition polynomial. If RAPs (see below) are being used, intermediate random coins (for use in permutation arguments) are drawn after the previous columns have been committed to.
2. Read the commitment to the constraint composition polynomial evaluations (over the LDE domain), use that to update the public coin, and sample the out-of-domain point z.
3. Evaluate the constraints at the provided out-of-domain point z based on prover-supplied trace values. Compute the evaluations of the constraint composition polynomial at the same point from the column values. Check for consistency between values. Reseeding is done after each read.
4. Perform the FRI protocol: Draw coefficients for computing the DEEP composition polynomial and instantiate a FRI verifier for the layer commitments provided in the channel. Draw query positions for the LDE domain, read the evaluations of the trace and constraint polynomials at those positions. Use those to compute evaluations of the DEEP composition polynomial and verify that these are from a low-degree polynomial.

Randomized Air with Preprocessing (RAPs): An additional feature desired for efficiency in STARKS is known as Randomized Air with Preprocessing (RAP). With RAPs, additional columns of the trace are committed to with access to random coins based on the original columns. This allows use of the Schwarz-Zippel lemma to show that, for instance, two columns are permutations of each other. This can be done by checking

$${\prod }_{i = 1}^{n} ( {a}_{i} + γ ) = {\prod }_{i = 1}^{n} ( {b}_{i} + γ ) ,$$

where aᵢ and bᵢ are the i-th entry in each column, and γ is randomly chosen after those values have been comitted to. With high probability, this only holds if the two sets {αᵢ} and {bᵢ} are permutations of each other [QWC12]. By supplying a known permutation σ to the verifier, they can run a check that

$${\prod }_{i = 1}^{n} ( {a}_{i} + α {ω}^{i} ) = {\prod }_{i = 1}^{n} ( {a}_{i} + α {ω}^{σ ( i )} + γ )$$

(where α is randomly chosen along with γ), which indicates that a αᵢ=α_{σ}(i) for all i=1, . . . , n. This is useful for enforcing equality over great distances in the execution trace, and is referred to as copy constraints with RAPs.

ICE-FROST Signature

The ICE-FROST protocol is a novel adaptation of the FROST protocol. The goal is to allow a subnet to generate signatures with a t-out-of-n threshold in a decentralized environment without any single trusted or semi-trusted party, and in the potential presence of malicious actors. Compared to the original FROST, our construction makes the key generation robust: enough honest actors can agree on the group's public key even in presence of malicious parties and without any rerun. In addition, honest actors can reliably identify misbehaving participants and exclude them from the scheme. At any point of time, honest actors maintain the same list of honest participants and can ignore any message from other parties.

For completeness, below is the detailed summary of the protocol.

Assumptions:
[symbol] is a group of prime order q in which the DDH problem is hard. g is a generator of that group.
The threshold t and the n participants are chosen by the subnet.
Each participant has or receives a unique id.
Each participant has access to a broadcast function. Each message published using broadcast is automatically signed and available to everyone.
Each participant Pᵢ is given an index i between 1 and q−1. For simplicity we assume that the n participants receive indices 1 to n but we only need them to be unique and non-zero.
Honest participants want to sign a message m agreed upon externally to the scheme.

Key Generation Phase

Let H be a hash function whose output is in [symbol] _{q}*. Let Enc and Dec be symmetric encryption and decryption functions. Let K be a key derivation function compatible with Enc and Dec.

Round 1
1. Every participant Pᵢ samples t random values, and uses these values as coefficients to define a degree t−1 polynomial ƒ₁(x)=Σⱼ₌₀^{t-1}αᵢⱼx^{j}.
2. Every Pᵢ computes a proof of knowledge to the corresponding secret αᵢ₀ by calculating σᵢ=(R_{i,μ}_{ᵢ}), such that, [symbol] ᵢ=g^{k}, cᵢ=H(i, Φ, g^{α}^{ᵢ₀}, Rᵢ), μᵢ=k+αᵢ₀·cᵢ, with Φ being a context string to prevent replay attacks.
3. Every Pᵢ samples skᵢ randomly and computes pkᵢ=g^{sk}^{ᵢ}.
4. Every Pᵢ computes a proof of knowledge to the secret key skᵢ by calculating τᵢ=(Sᵢ, vᵢ), such that, Sᵢ=g^{k}, dᵢ=H(i,Φ,pkᵢ,Sᵢ), vᵢ=k+skᵢ·dᵢ, with Φ being a context string to prevent replay attacks.
5. Every participant Pᵢ computes a public commitment \vec{C}ₗ= [symbol] ϕᵢ₀, . . . , ϕᵢ₍ₜ₋₁₎ [symbol] , where ϕ=ᵢⱼ=g^{α}^{ᵢⱼ},0≤j≤t−1.
6. Every Pᵢ broadcasts \vec{C}ₗ=σᵢ,pkᵢ,τᵢ.
7. Upon receiving \vec{C}ₗ, σₗ, pk₁, τₗ from participant 1≤l≤n, l≠i, participant Pᵢ verifies σᵢ=(Rₗ, μₗ) by checking Rₗ [symbol] g^{μ}^{ₗ}·ϕₗ₀^{-c}^{ₗ}, where cₗ=H(l, Φ, ϕₗ₀Rₗ), and τₗ=(Sₗ, vₗ) by checking Sₗ [symbol] g^{v}^{ₗ}·pkₗ^{-d}^{ₗ}, where dₗ=H(l, Φ, pkₗ, Sₗ). On failure, Pᵢ broadcasts (malicious, Pₗ) and excludes Pₗ from its list of participants.
8. If the number of remaining participants for Pᵢ is below a certain value decided by the subnet, the key generation is aborted. If not, the remaining participants advance to Round 2. For simplicity, we will still refer to the remaining participants as Pᵢ(i∈ [symbol] 1,n [symbol] ), even though some may have been eliminated at the last step of Round 1.

Round 2
1. Each Pᵢ does the following. For each Pᵢ, l·i:
   Compute a Diffie-Hellman key dhkᵢₗ=pk^{sk}^{ᵢ} and a symmetric key kᵢₗ=K(dhkᵢₗ)
   Encrypt eᵢₗ=Encₖ_{ᵢₗ}(ƒᵢ(l)).
   Broadcast ((i,l), eᵢₗ).
2. Upon receiving ((l, i), eₗᵢ) from participant 1≤l≤n, l≠i, participant Pᵢ does the following:
   Compute dhkₗᵢ=pkₗ^{sk}^{ᵢ}andkₗᵢ=K(dhkₗᵢ).
   Decrypt δ=Decₖ_{ₗᵢ}(eₗᵢ).
   Verify the share by checking

$${g}^{δ} {=}^{?} {\prod }_{k = 0}^{t - 1} {ϕ}_{lk}^{{i}^{k} {mod}_{q}} .$$

If the share is incorrect, initiate the procedure complain.
3. Participants resolve all complaints with the procedure exclude. If the number of remaining participants is below a certain value decided by the subnet, the key generation is aborted. For simplicity, we will still refer to the remaining participant as Pᵢ(iin [symbol] 1, n [symbol] ), even though some may have been eliminated at the previous step.
4. Each Pᵢ calculates their long-lived private signing share by computing sᵢ=Σₗ₌₁ⁿƒₗ(i), stores Sᵢ securely, and deletes each ƒᵢ(i).
5. Each Pᵢ calculates their public verification share Yᵢ=g^{s}^{ᵢ}, and the group's public key Y=Πⱼ₌₀ⁿϕⱼ₀. Any participant can compute the verification share of any other participant by calculating

$${Y}_{i} = {\prod }_{j = 1}^{n} {\prod }_{k = 0}^{t - 1} {ϕ}_{jk}^{{i}^{k} {mod}_{q}} .$$

Each Pᵢ then broadcast Y.

Complain(i, l)
1. Pᵢ computes a proof that dhkᵢₗ is well-formed, which is a proof of knowledge of skᵢ such that (pkᵢ, pkₗ, kᵢₗ) is of the form pkᵢ=g^{sk}^{ᵢ},kᵢₗ=pkₗ^{sk}^{ᵢ}. To do so it proceeds as follow:
   It computes A₁=g^{r}, A₂=pkₗ^{r}, where and h=H(pkᵢ, pkₗ, kᵢₗ, A₁, A₂).
   It computes z=r+h·skᵢ
   The proof is π=(A₁,A₂,z).
2. Pᵢ broadcasts the message (complaint, Pᵢ, Pₗ, kᵢₗ, π)
   exclude (complaint, Pᵢ, Pₗ, kᵢₗ, π)
1. Verify the proof by checking Aₗ·pkᵢ^{h} [symbol] g^{z}·A₂·kᵢₗ^{h} [symbol] pkₗ^{z} where π=(A₁, A₁, z) and h=H(pkᵢ, pkₗ, kᵢₗ, A₁, A₂). If the proof is valid, go to step 2. Else, broadcast (malicious, Pᵢ), exclude Pᵢ from the list of participants and terminate the procedure.
2. If there is an entry ((l, i), eₗᵢ) published by Pⱼ, go to step 3. Else, broadcast (malicious, Pᵢ), exclude Pᵢ from the list of participants and terminate the procedure.
3. Compute δ=Dec_{K(k}_{ᵢₗ}₎(eₗᵢ) Verify the decrypted share by checking

$${g}^{δ} {=}^{?} {\prod }_{k = 0}^{t - 1} {ϕ}_{lk}^{{i}^{k} {mod}_{q}} .$$

If the share is correct, broadcast (malicious, Pₗ) and exclude Pᵢ from the list of participants. Else, broadcast (malicious, Pₗ) and exclude Pₗ.

Signing Phase

We assume that a key generation phase has been successfully completed. The n remaining participants now each hold a secret share, and the group's public key is Y. Let H₁, H₂ be hash functions whose outputs are in [symbol] _{q}*.

Round 1
1. The subnet selects randomly S⊂ [symbol] 1,n [symbol] , |S|=s, s≥t the index of signing participants. The signing participants are Pᵢ,i∈S.
2. Each Pᵢ,i∈S, samples single-use nonces
3. Each Pᵢ broadcasts (Dᵢ,Eᵢ) where Dᵢ=g^{d}^{ᵢ}andEᵢ=g^{e}^{ᵢ}.

Round 2
1. Each Pᵢ constructs B= [symbol] (1, Dₗ, Eₗ) [symbol] _{l∈S}, computes the binding values ρₗ=H₁(l, m, B),l∈S, then derives the group commitment R=Π_{l∈S} Dₗ·(Eₗ)^{ρl} and the challenge c=H₂(R, Y, m).
2. Each Pᵢ computes their response using their long-lived secret share sᵢ by computing zᵢ=dᵢ+(eᵢ,ρᵢ)+λᵢ·sᵢ·c using S to determine the i^{th} Lagrange coefficient λᵢ.
3. Each Pᵢ deletes (dᵢ, Dᵢ, eᵢ, Eᵢ) from their local storage, and then broadcasts zᵢ.
4. Each Pᵢ does the following:
   Upon receiving zₗ from participant Pₗ,l∈S,l≠i, verify the validity of the response by checking g^{z}^{ₗ} [symbol] Rₗ·Yₗ^{c·λ}^{ₗ}. On failure, broadcast (malicious, Pₗ), exclude Pₗ from the list of participants and go to step 5.
   If all responses are correct, compute the group's response z=Σzᵢ.
   Broadcast the signature σ=(R, z) along with m and terminate the procedure.
5. If no signature has been generated and some participants have been excluded, go back to round 1 step 2 with the same S minus the excluded participants. If the resulting set has less than t members, abort the signature generation.

WCPRB Proof of Correctness

Theorem 1. Algorithm 4 solves Weak Causal Probabilistic Reliable Broadcast.

Proof sketch. To prove that Algorithm 4 solves Weak Causal Probabilistic Reliable Broadcast we prove that all the properties are satisfied. For readability we recall for each property its definition.

No duplication: No correct process delivers more than one message. The proof follows from the No duplication property of the PRB and from the fact that when a message is wcprb.Delivered, it is removed from the pending set.

Integrity: If a correct process delivers a message m, and the sender p is correct, then m was previously broadcast by p. The proof follows from the No integrity property of the PRB. In fact, in Algorithm 4, to be delivered, a message was necessary prb.Delivered by PRB.

ϵ-Validity: If the sender p is correct, and p broadcasts a message m, then p eventually delivers m with probability at least (1−ϵ). The proof follows from the ϵ-Validity property of the PRB and considering the following:

If p broadcasts m then Valid(m)=true at time t and p prb.Broadcast(m). Since ∀t′ ≥t, Valid(m)=true, then by the E-Validity of the PRB, p prb.Delivers message m, therefore, m is placed in pendingₚ and being valid it will be removed from pendingₚ and wcprb.Delivered by p.

ϵ-Consistency: Every correct process that delivers a message delivers the same message with probability at least (1−ϵ). The proof follows from the E-Consistency property of the PRB.

E-Totality: If a correct process delivers a message, then every correct process eventually delivers a message with probability at least (1−ϵ).

If p; delivers m then pᵢ prb.Delivers m and Valid(m)=true. If pᵢ prb.Delivers m then by the ϵ-Totality of the PRB, every other correct process pⱼ prb.Delivers m and place it in pending with probability (1−ϵ). We now have to prove that the message m in pending will be eventually delivered, e.g., Valid(m)=true at pⱼ. If Valid(m)=false at pⱼ at that time, it means that pⱼ has not yet delivered the messages delivered by pᵢ with which Valid(m)=true. Thanks to the ϵ-Totality of PRB, pⱼ will eventually prb.Deliver the same set of messages that pᵢ prb.Delivered, at that time, Valid(m)=true, and then pⱼ will wcprb.Deliver m.

Weak causal order: If a correct process p wcprb.Delivers a message m then m weakly casually precedes all the previously wcprb.Delivered messages. The proof simply follows from the definition of the Valid predicate and the check on Valid(m) before triggering wcprb.Deliver(m).

### Example Blockchain Architecture

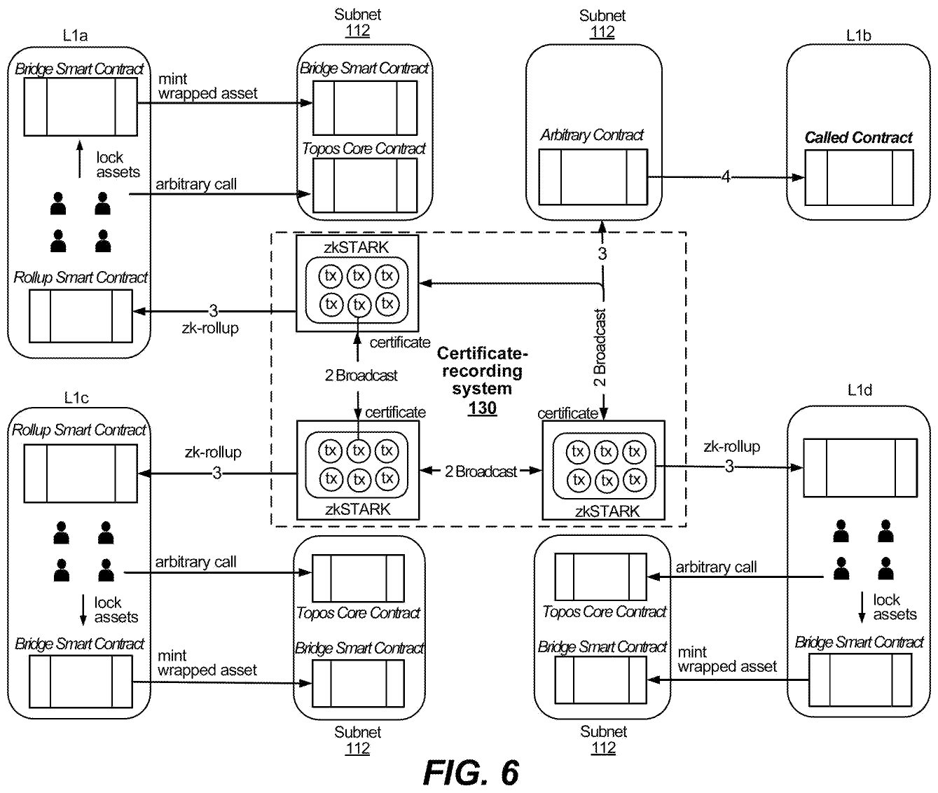

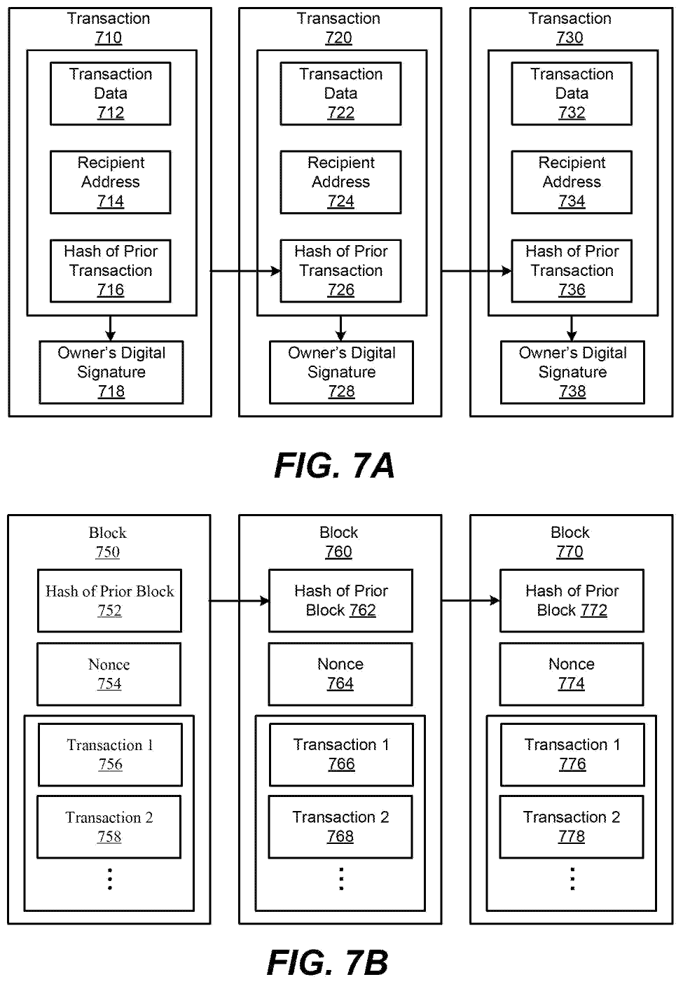

FIG. 7A is a block diagram illustrating a chain of transactions broadcasted and recorded on a blockchain, in accordance with some embodiments. The transactions described in FIG. 7A may correspond to any of the transactions and the transfer of blockchain-based units. A blockchain-based unit can be a cryptocurrency, a token, an NFT, a wrapped token, etc.

In some embodiments, a blockchain is a distributed system. A distributed blockchain network may include a plurality of blockchain nodes. Each blockchain node is a user or a server that participates in the blockchain network. In a public blockchain, any participant may become a blockchain node of the blockchain (permissionless). The blockchain nodes collectively may be used as a computing system that serves as a virtual machine of the blockchain. In some embodiments, the virtual machine or a distributed computing system may be simply referred to as a computer. Any blockchain node of a public blockchain may broadcast transactions for the nodes of the blockchain to record. Each digital wallet is associated with a private cryptographic key that is used to sign transactions and proves the ownership of a blockchain-based unit.

The ownership of a blockchain-based unit may be traced through a chain of transactions. A transaction may be referred to as a blockchain operation, which may include a transfer of a cryptocurrency or a token, a creation of a token, a recordation of an autonomous program protocol (e.g., a smart contract), execution of the autonomous program protocol, and another decentralized application operation. In FIG. 7A, a chain of transactions may include a first transaction 710, a second transaction 720, and a third transaction 730, etc. The transactions in FIG. 7A are typically recorded in the ledger of the blockchain. Each of the transactions in the chain may have a fairly similar structure except the very first transaction in the chain. The first transaction of the chain may be generated by a smart contract or a mining process and may be traced back to the smart contract that is recorded on the blockchain or the first block in which the blockchain-based unit was generated. While each transaction is illustrated as linking to a prior transaction in FIG. 7A, the transaction does not need to be recorded on consecutive blocks on the blockchain. For example, the block recording the transaction 710 and the block recording the transaction 720 may be separated by hundreds or even thousands of blocks. In some embodiments, the traceback of the prior block may be tracked by the hash of the prior block that is recorded by the current block. In other blockchains, there are no links among the transactions. The transactions are simply ordered temporally on the ledger that include a number of blocks. For example, in some embodiments, an account model is used and transactions do not have any references to previous transactions. In those blockchains, transactions are not chained and do not contain the hash of the previous transaction.

Referring to one of the transactions in FIG. 7A, for illustration, the transaction 720 may be referred to as a current transaction. Transaction 710 may be referred to as a prior transaction and transaction 730 may be referred to as a subsequent transaction. Each transaction includes a transaction data 722, a recipient address 724, a hash of the prior transaction 726, and the current transaction's owner's digital signature 728. The transaction data 722 records the substance of the current transaction 720. For example, the transaction data 722 may specify a transfer of a quantity of a blockchain-based unit (e.g., a coin, a blockchain token, etc.). In some embodiments, the transaction data 722 may include code instructions of a smart contract.

In some embodiments, the recipient address 724 is a version of the public key that corresponds to the private key of the digital wallet of the recipient. In one embodiment, the recipient address 724 is the public key itself. In another embodiment, the recipient address 724 an encoded version of the public key through one or more functions such as some deterministic functions. For example, the generation of the recipient address 724 from the public key may include hashing the public key, adding a checksum, adding one or more prefixes or suffixes, encoding the resultant bits, truncating the address, and/or other suitable algorithmic operations. The recipient address 724 may be a unique identifier of the digital wallet of the recipient on the blockchain.

The hash of the prior transaction 726 may be the hash of the entire transaction data of the prior transaction 710. Likewise, the hash of the prior transaction 736 is the hash of the entire transaction data of the transaction 720. The hashing of the prior transaction 710 may be performed using a hashing algorithm such as a secure hash algorithm (SHA) or a message digest algorithm (MD). In some embodiments, the owner corresponding to the current transaction 720 may also use the public key of the owner to generate the hash. The hash of prior transaction 726 provides a traceback of the prior transaction 710 and also maintains the data integrity of the prior transaction 710.

In generating a current transaction 720, the digital wallet of the current owner of the blockchain-based unit may use its private key to encrypt the combination of the transaction data 722, the recipient address 724, and the hash of prior transaction 726 to generate the owner's digital signature 728. To generate the current transaction 720, the current owner may specify a recipient by including the recipient address 724 in the digital signature 728 of the current transaction 720. The subsequent owner of the blockchain-based unit is fixed by the recipient address 724. In other words, the subsequent owner that generates the digital signature 738 in the subsequent transaction 730 is fixed by the recipient address 724 specified by the current transaction 720. To verify the validity of the current transaction 720, any nodes in the blockchain network may trace back to the prior transaction 710 (by tracing the hash of prior transaction 726) and locate the recipient address 714. The recipient address 714 corresponds to the public key of the digital signature 728. Hence, the nodes in the blockchain network may use the public key to verify the digital signature 728. Hence, a current owner who has the blockchain-based unit tied to the owner's blockchain address can prove the ownership of the blockchain-based unit. In this disclosure, it can be described as the blockchain-based unit being connected to a public cryptographic key of a party because the blockchain address is derived from the public key. For example, the computing server 140 may own blockchain-based units. The blockchain-based units are connected to one of the public cryptographic keys of the computing server 140.

The transfer of ownership of a blockchain-based unit may be initiated by the current owner of the blockchain-based unit. To transfer the ownership, the owner may broadcast the transaction that includes the digital signature of the owner and a hash of the prior transaction. A valid transaction with a verifiable digital signature and a correct hash of the prior transaction will be recorded in a new block of the blockchain through the block generation process.

FIG. 7B is a block diagram illustrating a connection of multiple blocks in a blockchain, in accordance with some embodiments. Each block of a blockchain, except the very first block which may be referred to as the genesis block, may have a similar structure. The blocks together may be referred to as the ledger of the blockchain. The blocks 750, 760, and 760 may each include a hash of the prior blockchain 752, a nonce 754, and a plurality of transactions (e.g., a first transaction 756, a second transaction 758, etc.). Each transaction may have the structure shown in FIG. 7A. An autonomous program protocol may also be stored in one of the transactions and execution results of the autonomous program protocol may be stored in subsequent transactions.

In a block generation process, a new block may be generated through a consensus mechanism such as mining (e.g., proof of work) or voting (e.g., proof of stake). For a mining process of a blockchain, any nodes in the blockchain system may participate in the mining process. The generation of the hash of the prior block may be conducted through a trial and error process. The entire data of the prior block (or a version of the prior block such as a simplified version) may be hashed using the nonce as a part of the input. The blockchain may use a certain format in the hash of the prior block in order for the new block to be recognized by the nodes as valid. For example, in one embodiment, the hash of the prior block needs to start with a certain number of zeroes in the hash. Other criteria of the hash of the prior block may also be used, depending on the implementation of the blockchain.

In a voting process, the nodes in a blockchain system may vote to determine the content of a new block. Depending on the embodiment, a selected subset of nodes or all nodes in the blockchain system may participate in the votes. For example, in some embodiments, a staking process is required before a node can participate in the voting process. When there are multiple candidates new blocks that include different transactions are available, the nodes will vote for one of the blocks to be linked to the existing block. The voting may be based on the voting power of the nodes.

By way of an example of a block generation process using mining, in generating the hash of prior block 762, a node may randomly combine a version of the prior block 750 with a random nonce to generate a hash. The generated hash is somewhat of a random number due to the random nonce. The node compares the generated hash with the criteria of the blockchain system to check if the criteria are met (e.g., whether the generated hash starts with a certain number of zeroes in the hash). If the generated hash fails to meet the criteria, the node tries another random nonce to generate another hash. The process is repeated for different nodes in the blockchain network until one of the nodes finds a hash that satisfies the criteria. The nonce that is used to generate the satisfactory hash is the nonce 764. The node that first generates the hash 762 may also select what transactions that are broadcasted to the blockchain network are to be included in the block 760. The node may check the validity of the transaction (e.g., whether the transaction can be traced back to a prior recorded transaction and whether the digital signature of the generator of the transaction is valid). The selection may also depend on the number of broadcasted transactions that are pending to be recorded and also the fees that may be specified in the transactions. For example, in some embodiments, each transaction may be associated with a fee (e.g., gas) for having the transaction recorded. After the transactions are selected and the data of the block 760 is fixed, the nodes in the blockchain network repeat the trial and error process to generate the hash of prior block 772 by trying different nonce. In embodiments that use voting to generate new blocks, a nonce may not be needed. A new block may be linked to the prior block by including the hash of the prior block.

New blocks may be continued to be generated through the block generation process. A transaction of a blockchain-based unit (e.g., an electronic coin, a blockchain token, etc.) is complete when the broadcasted transaction is recorded in a block. In some embodiments, the transaction is considered settled when the transaction is considered final. A transaction is typically considered final when there are multiple subsequent blocks generated and linked to the block that records the transaction.

In some embodiments, some of the transactions 756, 758, 766, 768, 776, 778, etc. may include one or more smart contracts. The code instructions of the smart contracts are recorded in the block and are often immutable. When conditions are met, the code instructions of the smart contract are triggered. The code instructions may cause a computer (e.g., a virtual machine of the blockchain) to carry out some actions such as generating a blockchain-based unit and broadcasting a transaction documenting the generation to the blockchain network for recordation.

### Computing Machine Architecture

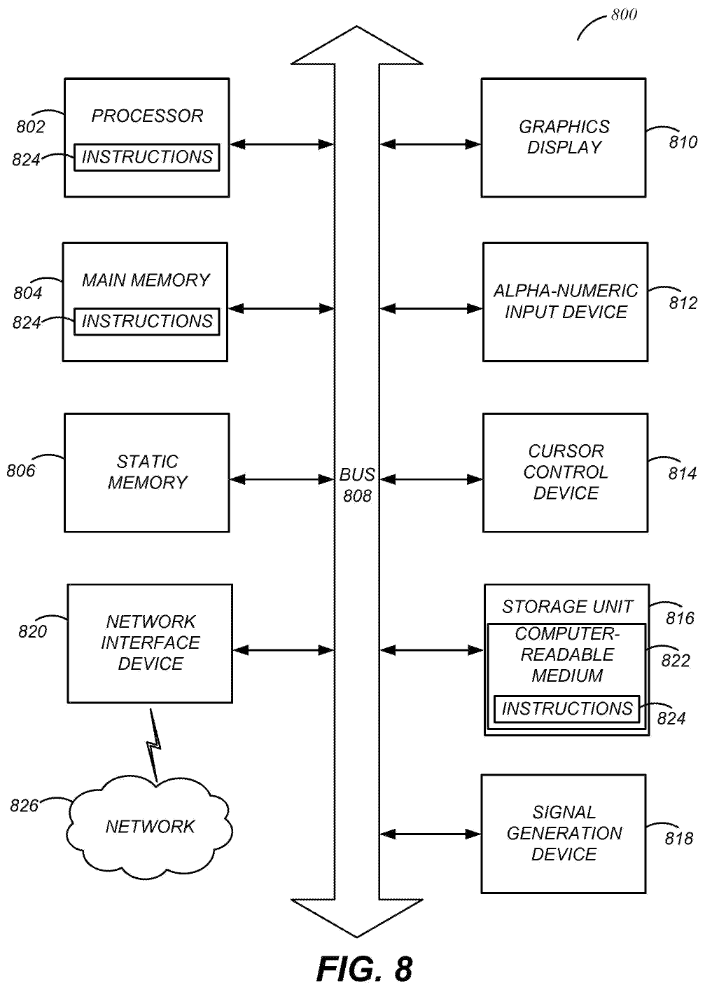

FIG. 8 is a block diagram illustrating components of an example computing machine that is capable of reading instructions from a computer-readable medium and executing them in a processor (or controller). A computer described herein may include a single computing machine shown in FIG. 8, a virtual machine, a distributed computing system that includes multiple nodes of computing machines shown in FIG. 8, or any other suitable arrangement of computing devices.

By way of example, FIG. 8 shows a diagrammatic representation of a computing machine in the example form of a computer system 800 within which instructions 824 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 8 may correspond to any software, hardware, or combined components shown in FIG. 1, including but not limited to, the computing device 180, the computing server 140, a subnet 112, a computing node of a certificate-recording system 130, a node of a blockchain network, and any computing node. While FIG. 8 shows various hardware and software elements, each of the components described in FIG. 1 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 824 that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processors (generally, processor 802) (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 804, and a static memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a computer-readable medium 822 on which is stored instructions 824 embodying any one or more of the methodologies or functions described herein. The instructions 824 may also reside, completely or at least partially, within the main memory 804 or within the processor 802 (e.g., within a processor's cache memory) during execution thereof by the computer system 800, the main memory 804 and the processor 802 also constituting computer-readable media. The instructions 824 may be transmitted or received over a network 826 via the network interface device 820.

While computer-readable medium 822 is shown in an example embodiment to be a single medium, the term “computer-readable medium” should be taken to include a single medium or multiple media (e.g., a centralized or distributed database, or associated caches and servers) able to store instructions (e.g., instructions 824). The computer-readable medium may include any medium that is capable of storing instructions (e.g., instructions 824) for execution by the machine and that cause the machine to perform any one or more of the methodologies disclosed herein. The computer-readable medium may include, but not be limited to, data repositories in the form of solid-state memories, optical media, and magnetic media. The computer-readable medium does not include a transitory medium such as a signal or a carrier wave.

### ADDITIONAL CONFIGURATION CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g., method, can be claimed in another claim category, e.g., computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

In some embodiments, a computer-readable medium includes one or more computer-readable media that, individually, distributedly, or together, include instructions that, when executed by one or more processors, cause the one or more processors to perform, individually, distributedly, or together, the steps of the instructions stored on the one or more computer-readable media. Similarly, a processor includes one or more processors or processing units that, individually, distributedly, or together, perform the steps of instructions stored on a computer-readable medium. When in this disclosure refers to one or more processors perform one or more steps, in various embodiments the one or more processors may individually, distributedly, or together perform those steps and the use of the phrase one or more processors by no means to imply that a single process has to perform every single step. For example, in a device that has multiple processors, one processor may perform step one and another processor may perform step two. Similar situation may apply to distributed computing.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A system comprising:
a first subnet, the first subnet comprising a first subnet computing node and a certificate interface in communication with the first subnet computing node,
wherein the first subnet computing node comprises one or more processors and memory, the memory storing code comprising instructions,
wherein the instructions, when executed, cause the one or more processors to:
execute one or more operations of the first subnet, and
generate a proof of computational integrity of the one or more operations; and
wherein the certificate interface is configured to generate a first certificate of the proof of computational integrity associated with the first subnet; and
a certificate-recording system in communication with the first subnet, the certificate-recording system configured to store a plurality of certificates from a plurality of subnets, the plurality of certificates comprising the first certificate associated with the first subnet and a second certificate associated with a second subnet different from the first subnet.

2. The system of claim 1, wherein the first subset further comprises a virtual machine that is configured to execute the instructions through the first subnet computing node, the virtual machine configured to execute a protocol for generating a zero-knowledge proof of the one or more operations, the zero-knowledge proof being the proof of computational integrity.

3. The system of claim 1, wherein the instructions stored in the memory of the first subnet computing node, when executed, further cause the one or more processors to:
receive a cross-subnet request from the second subnet;
receive a certificate of the second subnet from the certificate-recording system, the certificate containing a proof of the cross-subnet request;
verify the proof in the certificate; and
execute the cross-subnet request based on the proof.

4. The system of claim 1, wherein the certificate interface is configured to execute a protocol in generating certificates, the protocol is shared among the plurality of subnets.

5. The system of claim 1, wherein the first certificate comprises:
a state proof that a state of the first subnet is valid;
a list of one or more cross-subnet messages initiated from the first subnet to one or more other subnets; and
an inclusion proof that the list of one or more cross-subnet messages are included in the state of the first subnet.

6. The system of claim 1, wherein the first subnet is configured to operate in a plurality of states, each state comprising one or more operations, and the proof of computational integrity in the first certificate certifies validity of the one or more operations in one of the states compared to a previous state.

7. The system of claim 1, further comprising a blockchain configured to issue a plurality of blockchain units, wherein the blockchain units are used as staking tools for a node to participate in the certificate-recording system.

8. The system of claim 1, wherein the first subnet is configured to conduct a transaction of a wrapped token of a public blockchain that is outside of the plurality of subnets.

9. The system of claim 1, wherein the first subnet and the second subnet are configured to perform a cross-subnet operation that to verify the first certificate associated with the first subnet and the second certificate associated with the second subnet, and both certificates being stored in the certificate-recording system and the one or more operations of the first subnet being concealed from the second subnet in the cross-subnet operation.

10. The system of claim 1, wherein the first certificate stored in the certificate-recording system verifies the validity of the one or more operations of the first subnet but do not include sufficient information to conduct the one or more operations.

11. The system of claim 1, wherein the certificate-recording system is configured to arrange the plurality of certificates in a partial order under a plurality of threads.

12. The system of claim 1, wherein the first subnet comprises a consensus mechanism that allows a plurality of computing nodes to decide whether to generate the first certificate and the certificate-recording system is consensusless.

13. The system of claim 1, wherein the first subnet implements a Turing-complete virtual machine and the certificate-recording system is non-Turing-complete.

14. The system of claim 1, wherein the first subnet is a blockchain network and the certificate-recording system is a non-blockchain network.

15. A computer-implemented method, comprising:
executing one or more operations of a first subnet, the first subnet comprising a first subnet computing node and a certificate interface in communication with the first subnet computing node;
generating a proof of computational integrity of the one or more operations;
generating, by the certificate interface, a first certificate of the proof of computational integrity associated with the first subnet; and
broadcasting the certificate to a certificate-recording system that is configured to store a plurality of certificates from a plurality of subnets, the plurality of certificates comprising the first certificate associated with the first subnet and a second certificate associated with a second subnet different from the first subnet.

16. The computer-implemented method of claim 15, further comprising:
receiving a cross-subnet request from the second subnet;
receiving a certificate of the second subnet from the certificate-recording system, the certificate containing a proof of the cross-subnet request;
verifying the proof in the certificate; and
executing the cross-subnet request based on the proof.

17. The computer-implemented method of claim 15, wherein the first certificate comprises:
a state proof that a state of the first subnet is valid;
a list of one or more cross-subnet messages initiated from the first subnet to one or more other subnets; and
an inclusion proof that the list of one or more cross-subnet messages are included in the state of the first subnet.

18. The computer-implemented method of claim 15, wherein the first subnet is configured to conduct a transaction of a wrapped token of a public blockchain that is outside of the plurality of subnets.

19. The computer-implemented method of claim 15, wherein the first certificate stored in the certificate-recording system verifies the validity of the one or more operations of the first subnet but do not include sufficient information to conduct the one or more operations.

20. The computer-implemented method of claim 15, wherein the certificate-recording system is configured to arrange the plurality of certificates in a partial order under a plurality of threads.
